(19) United States
(12) Patent Application Publication
(10) Pub. No.: US 2010/0214317 A1
(43) Pub. Date: Aug. 26, 2010

(54) Monitoring and control device

(75) Inventors: Kei Miura, Tsu-shi (JP); Tomoaki Sasaki, Tsu-shi (JP); Hajime Yabu, Matsusaka-shi (JP); Yuichi Yoshimura, Hirakata-shi (JP); Katsuhiko Kimura, Hirakata-shi (JP); Yuichiro Naoi, Katano-shi (JP); Takashi Itou, Kawachinagano-shi (JP)

Correspondence Address: BACON & THOMAS, PLLC, 625 SLATERS LANE, FOURTH FLOOR, ALEXANDRIA, VA, 22314-1176, US

(73) Assignee: Panasonic Electric Works Co., Ltd., Osaka (JP)

(21) Appl. No.: 12/657,000

(22) Filed: Feb. 23, 2010

(30) Foreign Application Priority Data
Feb. 23, 2009 (JP) 2009-039123
Feb. 24, 2009 (JP) 2009-041530
May 21, 2009 (JP) 2009-123397
May 21, 2009 (JP) 2009-123402

(51) Int. Cl. G09G 5/00

(52) U.S. Cl. 345/641; 345/184; 345/173

(57) ABSTRACT

A monitoring and control device for use in a remote monitoring and control system includes a display unit provided with a screen for displaying operation buttons mated with the loads, an operation input unit operable by a user, the operation input unit including a touch switch panel superimposed on the screen of the display unit and a control unit for performing display control of the display unit and load control in response to the operation of the operation input unit. The control unit includes a display control unit for causing the display unit to display one operation page selected from a plurality of operation pages containing different combinations of operation buttons and a page changeover unit for changing over the operation page displayed on the display unit in response to a user's operation.

### FIELD OF THE INVENTION

The present invention relates to a monitoring and control device for use in a remote monitoring and control system that performs monitoring and control of a load by communications.

### BACKGROUND OF THE INVENTION

Conventionally, there are known systems for performing remote monitoring and control of loads, by which a transmission signal carrying switch on-off information is transmitted through a communications line to open or close a relay for turning on and off the electric power to be supplied to the loads.

One example of these remote monitoring and control systems is a centralized control system. The centralized control system includes terminal devices, which are formed of an operation terminal each having a switch and a control terminal each having a relay for turning on or off the electric power to be supplied to a load, and a central device formed of a transmission unit. Each of the operation terminal and the control terminal may be provided in plural numbers. The transmission unit, the operation terminal and the control terminal are connected to a two-wire type signal line. The transmission unit recognizes the operation terminal and the control terminal using the terminal addresses individually allocated to the operation terminal and the control terminal.

The transmission unit includes a memory that stores a control table as a data table in which the operation terminals and the control terminals are mated with each other by the addresses. If the information on an on-off operation of a switch belonging to any one of the operation terminals is notified through the use of a transmission signal (e.g., a time-division multiplexed transmission signal), the transmission unit transmits a relay-opening or relay-closing command through the transmission signal to the control terminal which is mated with the operation terminal in the control table. Responsive to this command, the control terminal opens or closes the relay thereof. Thus, the switch of the operation terminal is turned on or off to thereby control the load.

As a prior art example of the remote monitoring and control systems described above, there is proposed a monitoring and control device (or a selector switch) connected to a communications line and designed to enable a user to monitor and control a plurality of loads at one place (see, e.g., Japanese Patent Application Publication No. H9-261777, pages 5 to 7).

The monitoring and control device disclosed in Japanese Patent Application Publication No. H9-261777 includes a display panel (or a display unit) formed of a liquid crystal display, a transparent touch switch panel superimposed on the screen of the display panel, and a control unit for performing display control in the display panel and load control in response to the operation of the touch switch panel. The individual regions defined by operation buttons displayed on the screen of the display panel are used as switches (or operation portions). That is, it is possible for a user to control the loads corresponding to the operation buttons by touching the operation buttons displayed on the screen of the display panel. The operation status of each of the loads to be controlled is displayed on the display panel.

With this monitoring and control device, the switches required in a specific system configuration can be provided by changing the number of operation buttons displayed on the display panel. This makes it possible to cope with the increase or decrease in the number of switches using a single monitoring and control device. In this configuration, the mating relationship between the operation buttons on the screen of the display panel and the loads is determined by the addresses allocated to the respective operation buttons.

However, with the monitoring and control device configured as above, the number of operation buttons displayed on one screen page of the display panel is increased in proportion to the increase in the number of loads. This reduces the displayed size of the operation buttons and the gap between the operation buttons, which leads to increased likelihood of erroneous operation of the operation buttons. Moreover, the increase in the number of operation buttons displayed on one screen page of the display panel makes it difficult for a user to find a desired one of the operation buttons. That is, the operability becomes worse as the number of loads increases.

In addition, there is a need to use a display panel having a significantly large size in order to cope with the increase in the number of loads. This makes it difficult to achieve cost-effectiveness of the monitoring and control device, as compared to a case where a liquid crystal display module of relatively small size is used.

Further, in general, each of the operation terminals includes a plurality of switches and further that a plurality of loads are connected to each of the control terminals. In the control table of the transmission unit, the switches and the loads are mated with each other on a circuit-by-circuit basis. For example, in a case where there exists only a terminal address specific to each of the operation terminals even when the latter includes a plurality of switches, the terminal address may cover all of the switches provided in each of the operation terminals. This makes it impossible to specify one of the switches to be actually operated.

For that reason, different load numbers are allocated to the respective switches in each of the operation terminals, and the terminal addresses of the operation terminals added with the load numbers at their ends are used as switch addresses. By doing so, it is possible to specify one of the switches to be actually operated. Similarly, different load numbers are allocated to the loads in each of the control terminals, and the terminal addresses of the control terminals added with the load numbers at their ends are used as load addresses. In addition, the plurality of loads connected to each of the control terminals may constitute a single load circuit, in which case the terminal address of each of the control terminals is used as a load address.

Each of the operation terminals includes an address memory that stores the address (i.e., the terminal address+load number) to be set for each of the switches. The task of setting the address in the address memory is usually performed by a dedicated address-setting instrument provided independently of the operation terminals (see, e.g., Japanese Patent Application Publication No. 2006-340110). With this configuration, the address set by the address-setting instrument is transmitted to the operation terminal by wire communication or infrared communication and is stored in the address memory.

In case where the address is set by the dedicated address-setting instrument, however, the operation terminal has no unit for checking up the address thus set. Therefore, when changing a layout or in other like instances, the address set in the operation terminal needs to be checked up through the use of the address-setting instrument. This address checkup task is cumbersome and onerous. Since the address-setting instrument is not used for other purposes than the address-setting purpose, a manager of the remote monitoring and control system takes a responsibility for keeping the address-setting instrument safe. If the address-setting instrument is lost during safekeeping, it is necessary to purchase a new address-setting instrument when a need exists to change the address. This makes the manager feel burdensome.

In order that an address can be set without having to use any dedicated address-setting instrument, there has been proposed a monitoring and control device in which the function of setting an address to be stored in an address memory is added to an operation terminal itself (see, e.g., Japanese Patent Application Publication No. H10-243478).

The monitoring and control device disclosed in Japanese Patent Application Publication No. H10-243478 includes an operation input unit formed of a touch panel display having a display panel formed of a liquid crystal display and a transparent touch switch panel superimposed on the screen of the display panel. The individual regions defined by operation buttons displayed on the screen of the display panel are used as switches (or operation portions). That is, it is possible for a user to control the loads corresponding to the switches (operation buttons) by touching the switches displayed on the screen of the display panel. The operation status of each of the loads to be controlled is displayed on the display panel.

With this monitoring and control device, a plurality of switches can be realized by changing the displayed content of the display panel. This makes it possible to reduce the space occupied by the operation terminal, as compared to a case where the switches are arranged independently of one another.

In the monitoring and control device noted above, it is possible to select two active modes, namely an operation mode in which loads are controlled in response to the operation of the operation input unit and an address-setting mode in which addresses are set for the respective switches. The operation mode and the address-setting mode can be switched over by performing a specified operation with the operation input unit. In the address-setting mode, addresses can be set for the respective switches (the operation buttons) on the screen of the display panel using the numerical keypad displayed on the screen. The addresses thus set are stored in the address memory.

In order to check up whether the addresses have been accurately set for the respective switches in the monitoring and control device, there is a need to actually touch the switches in the operation mode to see that the operation state of each of the loads is changed. For the checkup of correctness of the addresses, the address-setting mode is terminated and converted to the operation mode. If the addresses are in error, it is necessary to return the operation mode back to the address-setting mode so that the addresses can be set again. This results in prolonged address setting time. The likelihood of occurrence of errors in setting the addresses grows higher if the system is large in scale and the monitoring and control device has an increased number of switches. The need to convert the operation mode to the address-setting mode and to set the addresses again each time of occurrence of errors leads to the loss of time in the address-setting task.

Further, there is also conventionally known a remote monitoring and control system for controlling loads, the configuration of which is illustrated in FIG. 35 (see, e.g., Japanese Patent Application Publication No. 2003-009260). In this remote monitoring and control system, operation terminals 310 and control terminals 320 are connected to a transmission control unit 300 through a two-wire type signal line Ls in a branched connection method (or in a multi-drop connection method). The operation terminals 310 and the control terminals 320 are allocated specific addresses and the transmission control unit 300 recognizes the operation terminals 310 and the control terminals 320 using the addresses. Each of the operation terminals 310 is provided with a switch S. A load L is connected to each of the control terminals 320. Each of the operation terminals 310 is further provided with indication lamps 310a and 310b, formed of an indication element (e.g., a light-emitting diode), for indicating the operation state of the load L. The load L is not limited to a particular one but an illumination load is frequently used as the load L.

The transmission control unit 300 delivers to the signal line Ls a transmission signal Vs having a format illustrated in (a) of FIG. 36. The transmission signal Vs is a time-division multiplex signal, which is a bipolar signal (±24V), including a synchronization signal SY indicative of signal delivery commencement, a mode data MD indicative of the mode of the transmission signal Vs, an address data AD for use in specifically calling out the operation terminals 310 or the control terminals 320, a control data CD for use in controlling the load L, a checksum data CS for use in detecting a transmission error, and a response waiting time slot WT, i.e., a time slot during which a response signal (monitoring data) is received from the operation terminals 310 or the control terminals 320. With the transmission signal Vs, data are transmitted through pulse width modulation (see (b) of FIG. 36).

If the address data AD carried by the transmission signal Vs via the signal line Ls coincide with the preset address, each of the operation terminals 310 and the control terminals 320 capture the control data CD from the transmission signal Vs and returns monitoring data, as a current mode signal (i.e., a signal transmitted by short-circuiting the signal line Ls via appropriate low impedance) to the transmission control unit 300 during the response waiting time slot WT of the transmission signal Vs.

In case where the data are transmitted from the transmission control unit 300 to a desired one of the operation terminals 310 or the control terminals 320, the transmission control unit 300 delivers a transmission signal Vs in which the mode data MD are kept in the control mode and in which the address data AD are brought into conformity with the address of the operation terminals 310 or the control terminals 320. As the transmission signal Vs is delivered to the signal line Ls, the operation terminal 310 or the control terminal 320, whichever have an address coinciding with the address data AD, capture the control data CD and returns monitoring data to the transmission control unit 300 during the response waiting time slot WT. Based on the relationship between the control data CD delivered and the monitoring data received during the response waiting time slot WT, the transmission control unit 300 confirms that the control data CD have been transmitted to the desired one of the operation terminal 310 or the control terminal 320 as desired. Responsive to the control data CD thus received, the control terminal 320 generates a load control signal for controlling the load L. In response to the control data CD received, the operation terminals 310 issue a display signal for performing the display for confirmation of the operation of the load L.

On the other hand, the transmission control unit 300 normally delivers, in a specified time interval, the transmission signal Vs in which the mode data MD are kept in a dummy mode. When the operation terminal 310 sends certain information to the transmission control unit 300, an interrupt signal as illustrated in (C) of FIG. 36 is generated in synchronism with the synchronization signal SY of a dummy mode transmission signal Vs. At this time, the operation terminal 310 sets an interrupt flag in preparation for subsequent delivery of information to and from the transmission control unit 300. Upon receipt of the interrupt signal, the transmission control unit 300 delivers transmission signals, in which case the mode data MD are kept in an interrupt polling mode and the higher half bits of the address data AD (e.g., the higher four bits in case of the address data AD being eight bits) are increased in order.

If the higher four bits of the address data AD carried by the transmission signals of the interrupt polling mode coincides with the higher four bits of the address set in the operation terminal 310, the operation terminal 310 that has generated the interrupt signal sends the lower half bits of the address thereof back to the transmission control unit 300 during the response waiting time slot WT. As noted above, the transmission control unit 300 searches for sixteen operation terminals 310 at one time to fine out the interrupt-signal-generating operation terminals 310 within a relatively short period of time.

Once the transmission control unit 300 acquires the address of the operation terminal 310 that has generated the interrupt signal, it delivers to the signal line Ls a transmission signal in which the mode data MD are kept in a monitoring mode and the address data AD are the ones thus acquired. Responsive to this transmission signal, the operation terminal 310 sends the desired information back to the transmission control unit 300 during the response waiting time slot WT. Finally, the transmission control unit 300 delivers a signal that instructs the interrupt-signal-generating operation terminal 310 to reset the interrupt, thereby canceling the interrupt flag.

As stated above, the information transmission from the operation terminal 310 to the transmission control unit 300 is completed by sending four times (in the dummy mode, the interrupt polling mode, the monitoring mode and the interrupt reset mode) from the transmission control unit 300 to the operation terminal 310. In order for the transmission control unit 300 to learn the operation state of a desired one of the control terminals 320, it may be sufficient for the transmission control unit 300 to merely deliver a transmission signal in which the mode data MD are kept in the monitoring mode.

The operations described above can be summarized as follows. If an input data to the operation terminal 310 is generated by the switch S, the operation terminal 310 sends monitoring data corresponding to the input data back to the transmission control unit 300. Then, the transmission control unit 300 transmits a control data CD to the control terminal 320. In response, the control terminal 320 outputs a load control signal to control the load L. A load monitoring input is applied to the control terminal 320 and a monitoring data corresponding to the load monitoring input is sent back to the transmission control unit 300. The monitoring data thus sent back is transmitted to the operation terminal 310. Responsive to this transmission signal, the operation terminal 310 outputs a monitoring signal which is usually used in turning on or off the indication lamp.

The remote monitoring and control system described above may be installed in a tenant building or other commercial institutions. In this case, there may possibly occur a problem in that the operation terminal 310 arranged in a place accessible by an unspecified number of persons is inadvertently operated to thereby stop the operation of the load L (e.g., to turn off an illumination load).

In view of this, there has been conventionally proposed to employ a relay device selectively changeable between a permission state in which the operation of an operation terminal connected to the downstream extension of a signal line is validated and an inhibition state in which the operation of the operation terminal is nullified. The relay device is connected to the upstream extension of the signal line, while the operation terminal 310 arranged in a place accessible by an unspecified number of persons is connected to the signal line at the downstream side of the relay device (see, e.g., Japanese Patent Application Publication No. H7-15773, the second embodiment). If the relay device is kept in the inhibition state, the operation of the operation terminal connected to the signal line at the downstream side of the relay device is nullified. This makes it possible to prevent an unspecified number of persons from erroneously operating the operation terminal.

With the prior art example disclosed in Japanese Patent Application Publication No. H7-15773, there is a need to provide the relay device between the operation terminal and the transmission control unit 300. This leads to an increased cost and makes the wiring design of the signal line complicated. Another problem resides in that a change in layout necessitates relocation of the relay device or re-wiring of the signal line.

### SUMMARY OF THE INVENTION

In view of the above, the present invention provides a monitoring and control device capable of enjoying enhanced operability and reducing the screen size of a display panel even when the device is used in combination with a multiplicity of loads.

Further, the present invention provides a monitoring and control device capable of enhancing the efficiency of an address-setting task by making it possible to check up the correctness of switch addresses without having to convert an address-setting mode to an operation mode.

Further, the present invention provides an operation terminal for a remote monitoring and control system capable of simplifying the system configuration as compared to the prior art examples, while making it possible to change over the validation and nullification of the operation of the operation terminal.

In accordance with a first embodiment of the present invention, there is provided a monitoring and control device for use in a remote monitoring and control system to monitor and control loads by communications, including: a display unit provided with a screen for displaying a plurality of operation buttons mated with the loads; an operation input unit operable by a user, the operation input unit including a touch switch panel superimposed on the screen of the display unit; and a control unit for performing display control of the display unit and load control in response to the operation of the operation input unit so that, if a user touches one of the operation buttons displayed on the display unit, the load corresponding to the touched operation button is controlled.

Herein, the control unit includes a display control unit for causing the display unit to display one operation page selected from a plurality of operation pages containing different combinations of operation buttons and a page changeover unit for changing over the operation page displayed on the display unit in response to a user's operation.

In this configuration, the display control unit causes the display unit to display one operation page selected from a plurality of operation pages containing different combinations of operation buttons. Responsive to the user's operation, the page changeover unit changes over the operation page displayed on the display unit. Even when the operation buttons correspond to a multiplicity of loads, it is therefore possible to reduce the number of operation buttons displayed on one screen page.

As compared to a case where all operation buttons are displayed on a single screen page, it is possible to increase the display size of each of the operation buttons and to broaden the gap between the neighboring operation buttons, which assists in reducing the likelihood of occurrence of erroneous operation of the operation buttons. Reduction in the number of operation buttons displayed on one screen page enables the user to easily find a desired one of the operation buttons.

Consequently, there is provided an advantage in that the operability is enhanced even when the operation buttons correspond to a multiplicity of loads. In addition, it is possible to reduce the screen size of the display unit. This makes it possible to use a relatively cheap small-sized liquid crystal display device as the display unit, which assists in making the monitoring and control device cost-effective.

In accordance with a second embodiment of the present invention, there is provided a monitoring and control device for use in a remote monitoring and control system to monitor and control loads by communications, including: a display unit provided with a screen for displaying a plurality of operation buttons mated with the loads; an operation input unit operable by a user, the operation input unit including a touch switch panel superimposed on the screen of the display unit; and a control unit for performing display control of the display unit and load control in response to the operation of the operation input unit so that, if a user touches one of the operation buttons displayed on the display unit, the load corresponding to the touched operation button is controlled; a clock unit for keeping apprised of a current clock time; and a storage unit that stores different data.

Herein, the control unit includes a display control unit for causing the display unit to display one operation page selected from a plurality of operation pages containing different combinations of operation buttons, a page changeover unit for changing over the operation page displayed on the display unit in response to a user's operation, a display interruption unit for turning off screen display of the display unit if the operation of the operation input unit is not detected for a predetermined time, a display resumption unit for resuming the screen display of the display unit if the operation input unit is re-operated while the screen display is turned off by the display interruption unit, and a page determination unit for determining one of the operation pages to be first displayed on the display unit when the screen display is resumed by the display resumption unit.

Further, the storage unit stores the operation pages in a mating relationship with different time zones and the page determination unit causes the display unit to initially display, at the time of resuming the screen display, one of the operation pages corresponding to one of the time zones to which the current clock time indicated by the clock unit belongs.

In this configuration, the page determination unit causes the display unit to initially display, at the time of resuming the screen display, one of the operation pages corresponding to one of the time zones to which the current clock time belongs. Therefore, the screen display of the display unit can be resumed from the operation page preliminarily designated with respect to each of the time zones. In other words, if an operation page having the highest operation frequency is preliminarily designated on a time zone basis according to the user's behavior patterns, the resumption of screen display can be started from the operation page having the highest operation frequency in the time zone to which the screen display resumption time point belongs. This provides an advantage in that it is possible to save the time otherwise required in changing over the operation page after resumption of the screen display and to enhance the operability of the monitoring and control device.

In accordance with a third embodiment of the present invention, there is provided a monitoring and control device for use in a remote monitoring and control system that includes an operation terminal provided with one or more switches each having a specific address and designed to deliver a transmission signal containing the address to a signal line in response to the operation of the switches, and a control terminal responsive to the transmission signal for controlling a load corresponding to the operated switch, the monitoring and control device including: an operation input unit provided with one or more switches; an address memory that stores the address of each of the switches; and a control unit operable in two active modes including an operation mode in which a transmission signal containing the address is delivered to the signal line in response to at least the operation of the switches and an address-setting mode in which the address to be stored in the address memory is set.

Herein, the control unit includes an operation checkup unit for starting an operation checkup mode in which the address-setting mode is stopped as a specified operation is made by the operation input unit during the address-setting mode and in which a transmission signal containing a provisional address composed of the address under setting operation is delivered to the signal line, the control unit being designed to resume the address-setting mode if the operation checkup mode comes to an end.

In this configuration, the operation checkup unit starts an operation checkup mode in which the address-setting mode is stopped as a specified operation is made by the operation input unit during the address-setting mode and in which a transmission signal containing a provisional address composed of the address under setting operation is delivered to the signal line.

Therefore, the correctness of the address set for each of the switches can be checked up without having to convert the address-setting mode to the operation mode. In other words, it is possible for the user to temporarily start the operation checkup mode and to attempt to perform the load control with the address under setting operation, while operating the control unit in the address-setting mode. Accordingly, the correctness of the address under setting operation can be checked up by checking the operation state of the load.

Therefore, there is no need to stop the address-setting mode and to covert the same to the operation mode, which should be performed in the prior art example in order to check up the correctness of the address. Even when the address is set in error, it is possible to immediately correct the address by terminating the operation checkup mode and resuming the address-setting mode. Consequently, it becomes possible to reduce the loss of time in the address-setting task. This provides an advantage of enhancing the efficiency of the address-setting task.

In accordance with a fourth embodiment of the present invention, there is provided an operation terminal for use in a remote monitoring and control system that includes an operation terminal provided with a plurality of switches each having a specific address, a control terminal connected to a plurality of loads each having a specific address, and a transmission control device connected to a signal line to which the operation terminal and the control terminal are connected in a branched manner, the transmission control device being designed to generate a control data for controlling one of the loads, in response to a monitoring data sent from the operation terminal when one of the switches is operated, and to transmit the control data to the control terminal connected the load having a mating relationship with the operated switch, the transmission control device being designed to, upon receiving an interrupt signal from the operation terminal through the signal line, search for the address of the operation terminal as a source of the interrupt signal, the operation terminal being designed to return a transmission signal containing the address thereof to the transmission control device in response to the address-searching operation of the transmission control device.

The operation terminal includes a transmission unit for transmitting the transmission signal and the interrupt signal through the signal line, an operation input reception unit provided with a plurality of switches and designed to receive an operation input of each of the switches, a storage unit that stores the address and a control unit for generating a monitoring data in response to the operation input received by the operation input reception unit and for causing the transmission unit to transmit a transmission signal containing the monitoring data.

Herein, the storage unit is designed to store a specific changeover address having a mating relationship with a switch of an additional operation terminal, wherein the control unit is designed to selectively change over a permission state in which the operation input received by the operation input reception unit is validated and an inhibition state in which the operation input is nullified, to perform generation of the monitoring data in response to the operation input and transmission of the transmission signal containing the monitoring data when in the permission state, to generate no monitoring data in response to the operation input when in the inhibition state, and to change over the permission state and the inhibition state in response to a control data sent from the transmission control device when the switch of the additional operation terminal having the changeover address is operated.

With this configuration, the control unit can be changed over from the permission state to the inhibition state and vice versa by operating the switch of the additional operation terminal. The operation input received by the operation input reception unit is nullified in the inhibition state. Therefore, there is no need to install a relay device between the operation input reception unit and the transmission control device, which needs to be installed in the prior art example. This provides an advantage in that it becomes possible to make the system configuration simpler than the prior art example while permitting the changeover of validation and nullification of the operation.

### BRIEF DESCRIPTION OF THE DRAWINGS

The objects and features of the present invention will become apparent from the following description of embodiments, given in conjunction with the accompanying drawings, in which:

FIGS. 1A to 1C are views illustrating different display examples on a display panel employed in a monitoring and control device in accordance with a first embodiment of the present invention;

FIG. 2 shows a remote monitoring and control system that makes use of the monitoring and control device in accordance with the first embodiment of the present invention;

FIG. 3 illustrates a format of communications command used in the monitoring and control device in accordance with the first embodiment of the present invention;

FIG. 4 is a schematic front view showing the outward appearance of the monitoring and control device in accordance with the first embodiment of the present invention;

FIG. 5 is a schematic block diagram showing the monitoring and control device in accordance with the first embodiment of the present invention;

FIG. 6 is a schematic block diagram showing a control terminal employed in the monitoring and control device in accordance with the first embodiment of the present invention;

FIG. 7 illustrates one display example on a display panel employed in the monitoring and control device in accordance with the first embodiment of the present invention;

FIG. 8 is a sequence diagram illustrating one operation example of the monitoring and control device in accordance with the first embodiment of the present invention;

FIG. 9 is a sequence diagram illustrating one operation example of the monitoring and control device in accordance with the second embodiment of the present invention;

FIG. 10 is a flowchart illustrating the operation of another configuration example of the monitoring and control device in accordance with the second embodiment of the present invention;

FIG. 11 is a sequence diagram illustrating another operation example of the monitoring and control device in accordance with the second embodiment of the present invention;

FIGS. 12A and 12B illustrate the operation of a monitoring and control device in accordance with a third embodiment of the present invention;

FIG. 13 is a flowchart illustrating the operation of the monitoring and control device in accordance with the third embodiment of the present invention;

FIG. 14 is another flowchart illustrating the operation of the monitoring and control device in accordance with the third embodiment of the present invention;

FIG. 15 is a schematic block diagram showing the monitoring and control device in accordance with a fourth embodiment of the present invention;

FIG. 16 is a flowchart illustrating the operation of a monitoring and control device in accordance with a fourth embodiment of the present invention;

FIG. 17 is a sequence diagram illustrating one operation example of the monitoring and control device in accordance with the fourth embodiment of the present invention;

FIG. 18 is a flowchart illustrating the operation of a monitoring and control device in accordance with a fifth embodiment of the present invention;

FIG. 19 is a schematic block diagram showing the configuration of a monitoring and control device in accordance with a sixth embodiment of the present invention;

FIG. 20 shows a remote monitoring and control system that makes use of the monitoring and control device in accordance with the sixth embodiment of the present invention;

FIG. 21 is a schematic block diagram showing the monitoring and control device in accordance with the sixth embodiment of the present invention;

FIG. 22 illustrates an operation page employed in the monitoring and control device in accordance with the sixth embodiment of the present invention;

FIG. 23 illustrates a selection screen employed in the monitoring and control device in accordance with the sixth embodiment of the present invention;

FIG. 24 illustrates a setting page employed in the monitoring and control device in accordance with the sixth embodiment of the present invention;

FIG. 25 illustrates an operation checkup page employed in the monitoring and control device in accordance with the sixth embodiment of the present invention;

FIG. 26 illustrates another operation checkup page employed in the monitoring and control device in accordance with the sixth embodiment of the present invention;

FIG. 27 is a flowchart illustrating the operation in an operation checkup mode of the monitoring and control device in accordance with the sixth embodiment of the present invention;

FIG. 28 illustrates a setting menu screen employed in a monitoring and control device in accordance with a seventh embodiment of the present invention;

FIG. 29 illustrates a display color setting page employed in the monitoring and control device in accordance with the seventh embodiment of the present invention;

FIG. 30 is a flowchart illustrating the operation in a display color setting mode of the monitoring and control device in accordance with the seventh embodiment of the present invention;

FIG. 31 illustrates a type setting page employed in the monitoring and control device in accordance with the seventh embodiment of the present invention;

FIG. 32 is a perspective view showing an operation terminal in accordance with an eighth embodiment of the present invention;

FIGS. 33A and 33B illustrate different screens employed in the operation terminal in accordance with the eighth embodiment of the present invention;

FIG. 34 is a system configuration diagram showing a remote monitoring and control system that includes the operation terminal in accordance with the eighth embodiment of the present invention; and

FIG. 35 is a system configuration diagram showing a conventional remote monitoring and control system;

FIG. 36 is a view for explaining a transmission signal used in a conventional operation terminal.

### DETAILED DESCRIPTION OF THE PREFERRED EMBODIMENTS

Hereinafter, embodiments of the present invention will be described with reference to accompanying drawings which form a part hereof.

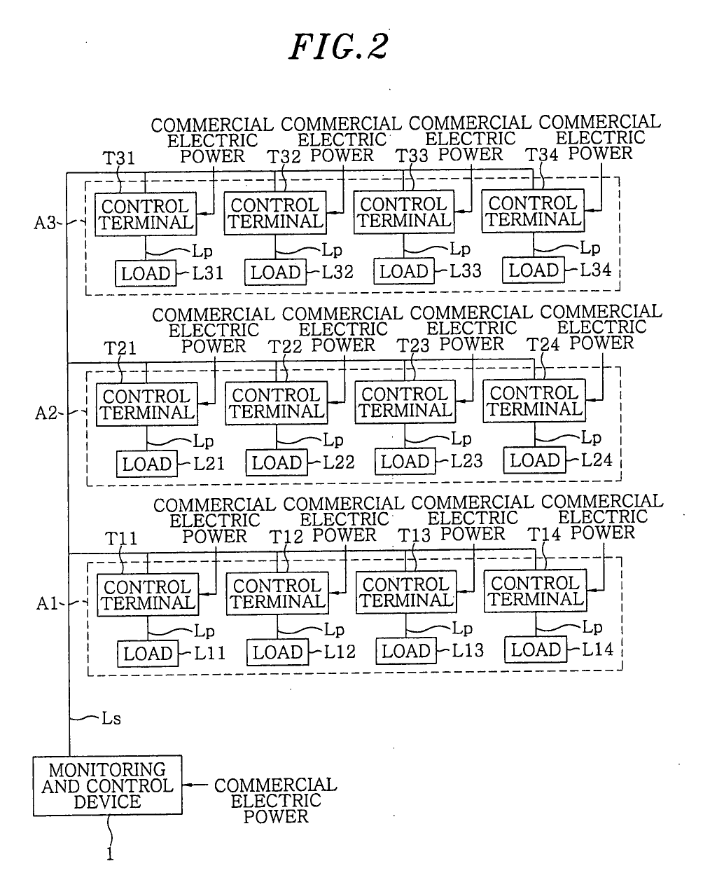

Each of the monitoring and control devices described below in respect of different embodiments is used in a remote monitoring and control system shown in FIG. 2.

In the remote monitoring and control system shown in FIG. 2, control terminals T11 through T14, T21 through T24 and T31 through T34 are bus-connected to a single monitoring and control device 1 through a communications line Ls. In the following description, the control terminals T11 through T14, T21 through T24 and T31 through T34 will be simply referred to as “control terminals T” if there is no need to distinguish them from one another. The connection between the monitoring and control device 1 and the control terminals T is not limited to the wire connection. Alternatively, a communications path using wireless communications technology, e.g., a wireless LAN, may be formed between the monitoring and control device 1 and the control terminals T.

Loads L11 through L14, L21 through L24 and L31 through L34, such as illumination devices or air-conditioning devices, are connected to the control terminals T11 through T14, T21 through T24 and T31 through T34 through power supply lines Lp. In the following description, the loads L11 through L14, L21 through L24 and L31 through L34 will be simply referred to as “loads L” if there is no need to distinguish them from one another. Each of the control terminals T is provided with a power control unit for controlling the electric power outputted to each of the loads L (e.g., a power control circuit to be described later). The power control unit controls the operation state of each of the loads L by controlling (e.g., turning on or off) the electric power supplied to each of the loads L. The control terminals T and the monitoring and control device 1 are supplied with commercial electric power (of AC 100V) to secure internal electric power.

It is assumed herein that the loads L11 through L14, L21 through L24 and L31 through L34 are installed in three installation areas A1, A2 and A3 divided on a floor-by-floor basis or a room-by-room basis. The loads L of the remote monitoring and control system may be either the same kind or the combination of different kinds. The loads L and the control terminals T may be integrally formed with each other.

The monitoring and control device 1 functions as load control switches to be described later. The switches and the control terminals T are mated with each other by their addresses. In other words, each of the control terminals T is allocated a specific address and each of the switches of the monitoring and control device 1 is mated with the address of each of the control terminals T. This makes it possible to control the load L corresponding to the switch actually operated. The monitoring and control device 1 is provided with a control table indicative of the correspondence relation between the switches and the control terminals T.

Brief description will now be made on the operation of the remote monitoring and control system.

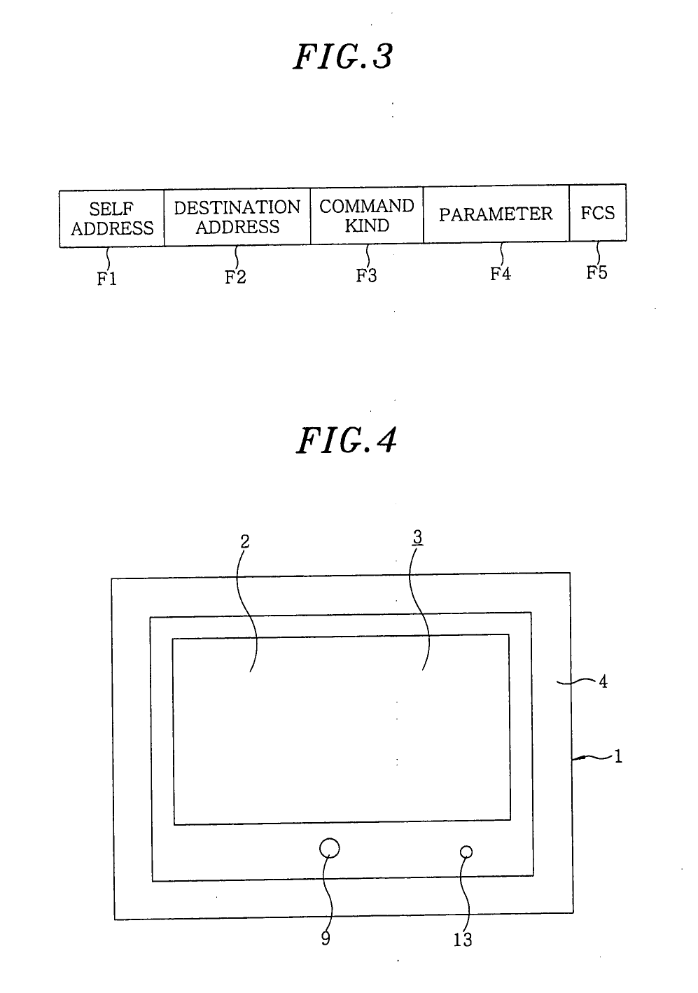

If one of the switches of the monitoring and control device 1 is operated, the monitoring and control device 1 delivers to the communications line Ls a load control request that designates the address of one of the control terminals T corresponding to the operated switch. In the communications between the monitoring and control device 1 and the control terminals T, use is made of a communications command as illustrated in FIG. 3, which includes a self address (e.g., the address of the monitoring and control device 1 in case of a load control request command) F1, a destination address F2, a command kind F3 indicating the load control request and the load control response to be set forth later, a parameter F4 indicating the content of monitoring and control (e.g., an on-operation or an off-operation) and a frame check sequence (FCS) F5 for detecting communications errors.

The control terminal T that has received the load control request from the monitoring and control device 1 controls the operation state of the corresponding load L based on the designated control content. Upon completing the control of the load L, the control terminal T returns to the monitoring and control device 1a load control response of the format illustrated in FIG. 3 for the purpose of confirming the operation state of the load L thus controlled. Responsive to the load control response, the monitoring and control device 1 displays the operation state of the load L.

Through this process, the operation of the monitoring and control device 1 can be reflected in the control of the load L.

### First Embodiment

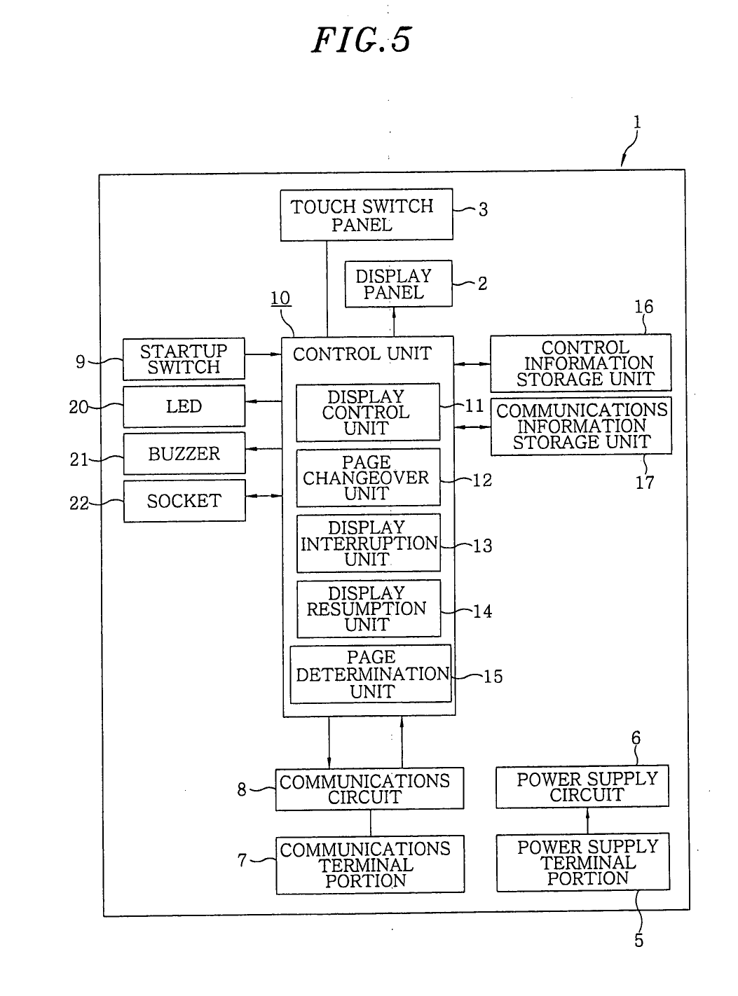

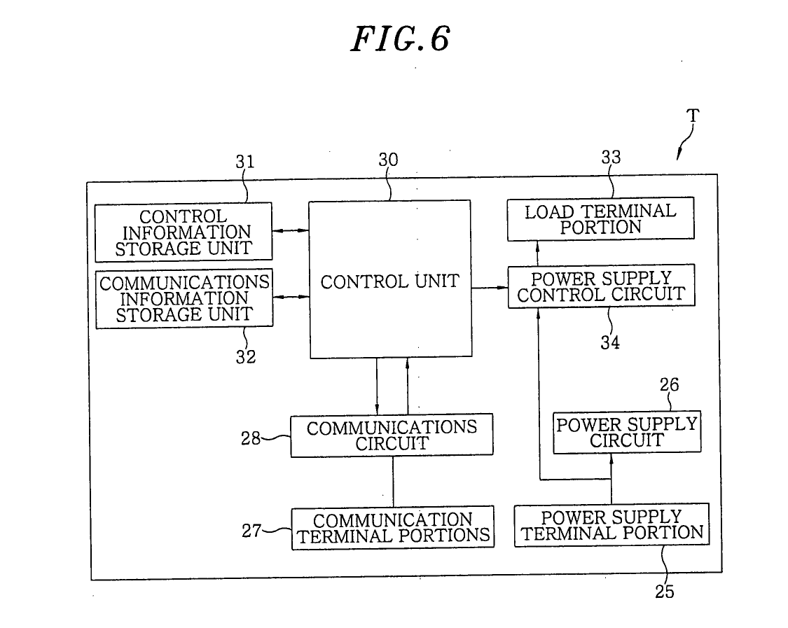

Referring to FIG. 4, the monitoring and control device 1 of the present embodiment includes a display panel (display unit) 2, which is formed by combining a backlight with a liquid crystal display device, and a transparent flat touch switch panel 3 superimposed on the screen (or the front surface) of the display panel 2. The display panel 2 and the touch switch panel 3 are arranged on the front surface of a base 4. The display panel 2 is not limited to the liquid crystal display device but may be, e.g., an electronic paper or an organic EL display.

The display panel 2 is of a matrix display type in which a multiplicity of pixels is arranged in a matrix pattern along the row and column directions. Figures or letters are represented by the combination of pixels. The touch switch panel 3 includes a transparent sheet member and a plurality of transparent electrode contact points arranged on the sheet member. The touch switch panel 3 is a resistance-pressure-sensitive touch switch panel that outputs a signal indicating the point on the sheet member touched by a finger or the like. The display panel 2 and the touch switch panel 3 cooperate to form a touch panel display. The touch switch panel 3 is not limited to the resistance-pressure-sensitive touch switch panel but may be, e.g., a capacitance switch or an optical switch.

The touch panel display serves to receive the user's operation input. The areas of the touch switch panel 3 defined by the operation buttons displayed on the screen of the display panel 2 are used as load control switches. Accordingly, the user can touch one of the operation buttons on the screen of the display panel 2 to control the load L corresponding to the touched operation button.

Referring to FIG. 5, the monitoring and control device 1 includes a power supply circuit 6 for supplying a direct current to internal circuits, the power supply circuit 6 connected to a power supply terminal portion 5 to which the power supply line Lp can be connected, a communications circuit 8 for sending and receiving communications commands, the communications circuit 8 connected to a communications terminal portion 7 to which the communications line Ls can be connected, and a control unit 10 for controlling display of the display panel 2 and controlling the loads L in response to the operation input of the touch switch panel 3. The control unit 10 is mainly including a microcomputer and is operated according to the program and data stored in a control information storage unit 16 and a communications information storage unit 17. The information required in controlling the loads L, e.g., a control table indicative of the correspondence relation between the switches (or the operation buttons) and the addresses of the control terminals T, is stored in the control information storage unit 16. The self address (namely, the address of the monitoring and control device 1) required in making communications is stored in the communications information storage unit 17. Examples of the communications circuit 8 include a serial communications circuit such as RS-485 or the like and a transmission circuit for Ethernet (registered trademark).

The monitoring and control device 1 further includes a startup switch 9 cooperating with the touch switch panel 3 to form an operation input unit for receiving the user's operation, a light-emitting diode (LED) 20 for indicating the on-state or off-state of electric power, a buzzer 21 for generating an operation sound when the touch switch panel 3 is operated, and a socket 22 to which can be fitted an external storage medium such as a memory card or the like. The startup switch 9 includes a mechanical switch arranged on the front surface of the base 4 and below the display panel 2. The startup switch 9 is used in starting up the touch panel display to initiate the screen display on the display panel 2. The external storage medium is used in setting load control or for other purposes. The control unit 10 or the communications circuit 8 of the monitoring and control device 1 may separated from a user interface such as the display panel 2 or the operation input unit and may be provided as an independent body.

The control unit 10 can be changed over between two active modes, namely an operation mode in which a communications command (or a load control request) is delivered to the communications line Ls in response to the operation of the switches (or the operation buttons) and a setting mode in which to perform allocation of addresses to the respective switches or various kinds of setting operations. The changeover of these active modes can be carried out by performing a specified operation, e.g., pressing the startup switch 9 for a long time.

In the operation mode, the control unit 10 causes the display panel 2 to display the load state (namely, the operation state of the loads L) in response to the communications command (or the load control response) received by the communications circuit 8 and performs load control in response to the operation of the touch switch panel 3 associated with the display content. In other words, the display panel 2 serves as a state display unit for displaying the current operation state of each of the loads to be monitored and controlled. The user can control the loads by operating the touch switch panel 3 according to the display on the display panel 2.

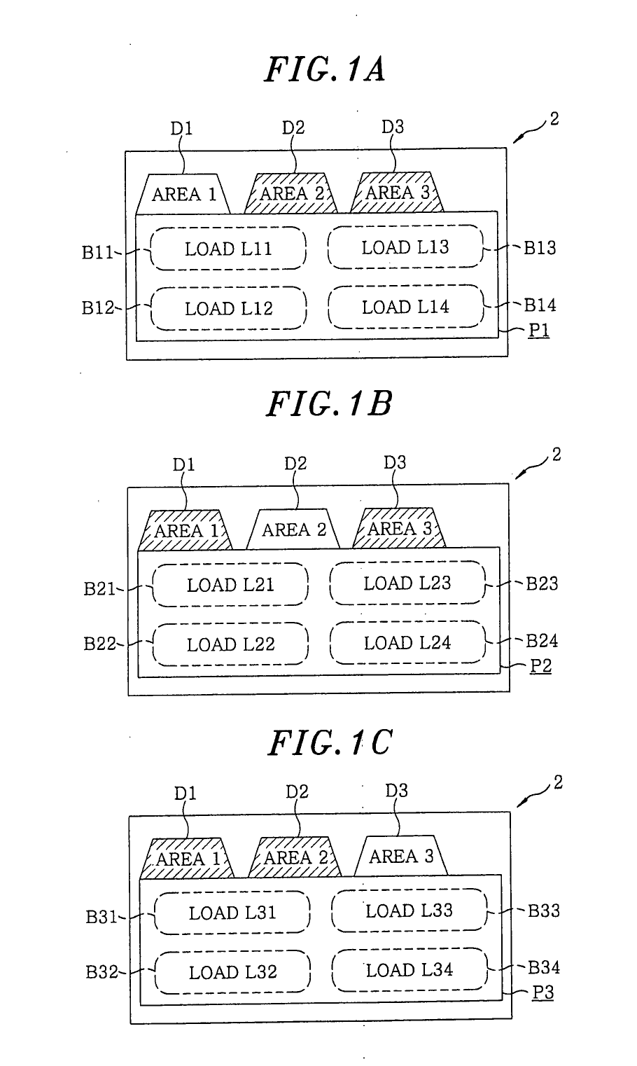

More specifically, the control unit 10 controls the display panel 2 so that, as illustrated in FIGS. 1A, 1B and 1C, the screen thereof can display operation pages containing a plurality of operation buttons B11 through B14, B21 through B24 and B31 through B34 (which will be simply referred to as “operation buttons B” if there is no need to distinguish them from one another). The areas of the touch switch panel 3 overlapping with the operation buttons B on the screen of the display panel 2 are used as individual switches. The user can apply an operation input for the control of loads by touching each of the switches of the touch switch panel 3 (namely, the portion of the touch switch panel 3 corresponding to each of the operation buttons B). In addition, the user can control one of the loads L corresponding to an arbitrary one of the operation buttons B by touching that operation button B.

Referring to FIG. 6, each of the control terminals T forming the remote monitoring and control system in cooperation with the monitoring and control device 1 includes a power supply circuit 26 for supplying a direct current to internal circuits, the power supply circuit 26 connected to a power supply terminal portion 25 to which the power supply line Lp can be connected, a communications circuit 28 for sending and receiving communications commands, the communications circuit 28 connected to a communications terminal portion 27 to which the communications line Ls can be connected, and a control unit 30 mainly having a microcomputer. The control unit 30 is operated according to the program and data stored in a control information storage unit 31 and a communications information storage unit 32. The operation state of each of the loads L is controlled by a power supply control circuit 34 that turns on or off the electric power outputted from a load terminal portion 33 to each of the loads L.

The monitoring and control device 1 is designed to monitor and control a multiplicity of loads L11 through L14, L21 through L24 and L31 through L34. Therefore, if the operation buttons B11 through B14, B21 through B24 and B31 through B34 corresponding to the loads L11 through L14, L21 through L24 and L31 through L34 are all displayed on one screen page of the display panel 2, the size of the operation buttons B becomes too small. This may possibly make the display of the load state illegible. Furthermore, reduction in the area of each of the operation buttons B may possibly make it difficult to touch and operate the operation buttons B.

In the present embodiment, therefore, the control unit 10 is designed to serve as a display control unit 11 for controlling the display panel 2 to display the operation buttons B on different operation pages and a page changeover unit 12 for changing over the operation pages displayed on the display panel 2. This is to keep relatively small the number of the operation buttons B displayed on one screen page of the display panel 2. The display control unit 11 causes the display panel 2 to display one operation page selected from a plurality of operation pages P1, P2 and P3 containing different combinations of operation buttons B as illustrated in FIGS. 1A to 1C. Responsive to the user's operation, the page changeover unit 12 changes over the operation pages P1, P2 and P3 displayed on the display panel 2.

Each of the operation pages P1, P2 and P3 employed in the present embodiment is capable of displaying four operation buttons B. One of the operation pages P1, P2 and P3 can be displayed by selecting one of tap-like page changeover buttons D1, D2 and D3 displayed above the operation pages P1, P2 and P3.

Each of the operation pages P1, P2 and P3 contains the combination of operation buttons B corresponding to the loads L arranged in one of the installation areas A1, A2 and A3. In an instance where the page changeover button D1 is selected as highlighted in FIG. 1A, the display panel 2 displays the operation page P1 containing the operation buttons B11 through B14 corresponding to the loads L11 through L14 arranged in the installation area A1. If the page changeover button D2 is selected in this state, the screen display of the display panel 2 is renewed to display, as illustrated in FIG. 1B, the operation page P2 containing the operation buttons B21 through B24 corresponding to the loads L21 through L24 arranged in the installation area A2. Similarly, If the page changeover button D3 is selected, the display panel 2 displays, as illustrated in FIG. 1C, the operation page P3 containing the operation buttons B31 through B34 corresponding to the loads L31 through L34 arranged in the installation area A3. On each of the operation pages P1, P2 and P3, there are displayed four operation buttons B, two in column (in the vertical direction in FIGS. 1A to 1C) and two in row (in the horizontal direction in FIGS. 1A to 1C). When the monitoring and control device 1 is supplied with electric power, the operation page P1 containing the operation buttons B11 through B14 is displayed as an initial screen page.

The operation buttons B can be distributed on the respective operation pages P1, P2 and P3 depending on the characters thereof. It is not always necessary that the operation buttons B corresponding to the loads L arranged in the same installation areas A1, A2 and A3 are distributed on the same operation pages P1, P2 and P3. As an alternative example, the operation buttons B identical in the kind of loads L (e.g., the operation buttons B for illumination devices or air-conditioning devices) may be distributed on the same operation pages P1, P2 and P3.

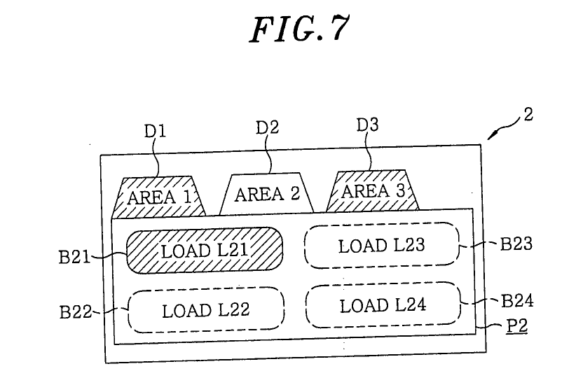

Each of the operation buttons B serves also to indicate the operation state of the corresponding load L. For example, if the loads L21 through L24 are all in an off-state, the perimeters of the operation buttons B21 through B24 are indicated in dot lines as illustrated in FIG. 2B. In contrast, if the load L21 is turned on, the perimeter of the operation button B21 corresponding to the load L21 is indicated in a solid line as illustrated in FIG. 7. At this time, the display color of each of the operation buttons B is also changed over depending on the on-off state of the loads L (e.g., green in case of an off-state and red in case of an on-state).

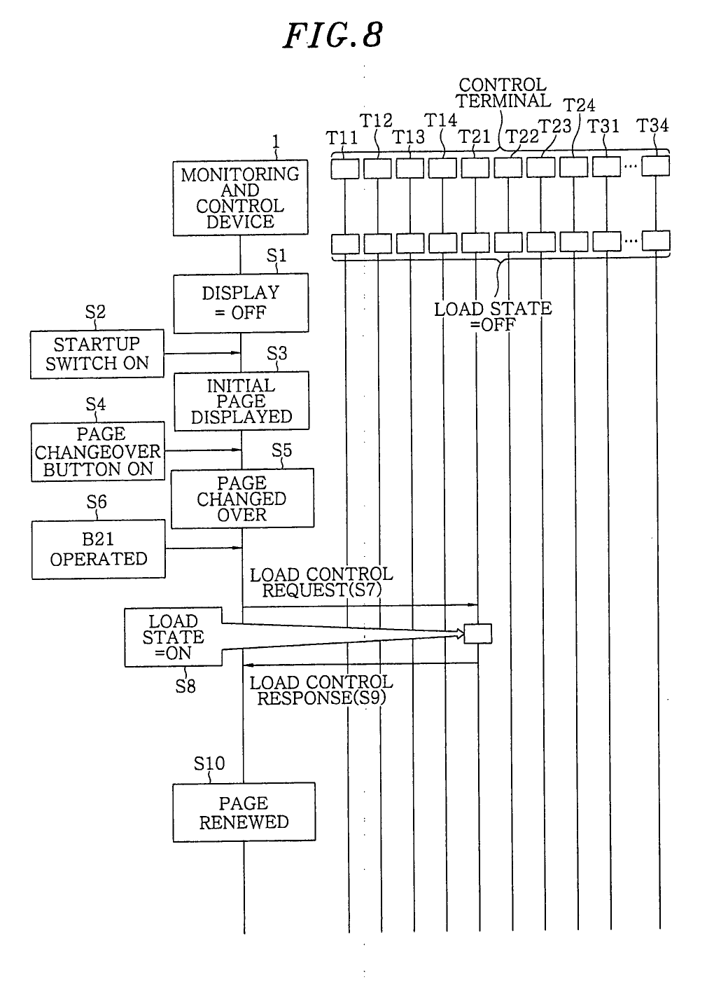

Next, the operation of the monitoring and control device 1 in accordance with the present embodiment will be described with reference to the sequence diagram shown in FIG. 8

If the startup switch 9 is pressed (step S2) while the screen display of the display panel 2 of the monitoring and control device 1 is in an off-state (step S1), the display panel 2 starts screen display (step S3). At this time, the operation page P1 containing the operation buttons B11 through B14 is displayed as an initial screen page on the display panel 2. In the example shown in FIG. 8, the loads L are all in an off-state at the time of starting the screen display. Therefore, the operation page P1 is displayed in the state as illustrated in FIG. 1A.

In order to turn on, e.g., the load L21, it is necessary to touch and operate the page changeover button D2 (step S4) so that the operation page P2 containing the operation buttons B21 through B24 can be displayed on the operation page P2 as illustrated in FIG. 1B (step S5). If the operation button B21 corresponding to the load L21 is touched (step S6) while the operation page P2 is displayed on the display panel 2, a load control request is transmitted from the monitoring and control device 1 to the control terminal T21 (step S7).

Upon receiving the load control request, the control terminal T21 analyzes the communications command (namely, the load control request) thus received and recognizes the load control request. At this time point, the control terminal T21 controls the power control circuit 34 thereof so that the load L21 can be turned on according to the control content (step S8). Subsequently, the control terminal T21 returns to the monitoring and control device 1 a load control response indicating that the load L21 is in an on-state (step S9).

Responsive to the load control response, the monitoring and control device 1 analyzes the communications command (namely, the load control response) thus received and recognizes the load control response. At this time point, the monitoring and control device 1 changes the display state of the operation button B21 corresponding to the load L21 according to the control content so that the screen page shown in FIG. 7 can be displayed on the display panel 2 (step S10). This makes it possible to notify the user of the change in the operation state of the load L21.

With the monitoring and control device 1 described above, a multiplicity of loads L is monitored and controlled but the operation buttons B corresponding to the respective loads L are divisionally displayed on a plurality of operation pages P1, P2 and P3. Therefore, it is possible to reduce the number of operation buttons B displayed on one screen page, as compared to a case where the operation buttons B are all displayed on a single screen page. This makes it possible to increase the display size of each of the operation buttons B and to broaden the gap between the neighboring operation buttons B, which assists in reducing the likelihood of occurrence of erroneous operation of the operation buttons B. Reduction in the number of operation buttons B displayed on one screen page enables the user to easily find a desired one of the operation buttons B, which helps enhance operability.

In case where the respective operation buttons B have the same display size, it is possible to reduce the screen size of the display panel 2 as compared to a case where the operation buttons B are all displayed on one screen page. This makes it possible to use a relatively cheap small-sized liquid crystal display device as the display panel 2, which assists in making the monitoring and control device 1 cost-effective.

### Second Embodiment

The monitoring and control device 1 of the present embodiment differs from that of the first embodiment in that, as shown in FIG. 5, the control unit 10 serves as a display interruption unit 13 for turning off the screen display of the display panel 2 if the touch switch panel 3 and the startup switch 9 as operation input units remain inoperative for more than a specified time and a display resumption unit 14 for resuming the screen display of the display panel 2 if the startup switch 9 is operated while the screen display is in an off-state.

More specifically, if the operation of the operation input units is not detected for more than a specified auto-off time, the display interruption unit 13 turns off the backlight of the display panel 2 and also turns off the screen display of the display panel 2 (or interrupts power output to the liquid crystal display device). If a specified operation of the operation input units (e.g., the pressing operation of the startup switch 9) is detected while the display panel 2 remains in an off-state, the display resumption unit 14 turns on the backlight and resumes the screen display of the display panel 2. This makes it possible to keep the backlight and the liquid crystal display device turned off in case where the operation input units remain inoperative for a prolonged time period. This assists in extending the lifespan of the display panel 2 and saving power consumption. The auto-off time is set in the setting mode.

The control unit 10 serves also as a page determination unit 15 for determining one of the operation pages P1, P2 and P3 (hereinafter referred to as “top page”) to be first displayed on the screen of the display panel 2 when the screen display is resumed by the display resumption unit 14. The page determination unit 15 ensures that one of the operation pages P1, P2 and P3 displayed on the display panel 2 immediately before the display interruption unit 13 turns off the screen display is stored as a final display page in a page information storage unit 19. The page determination unit 15 causes the final display page to be displayed as the top page at the time of resuming the screen display.

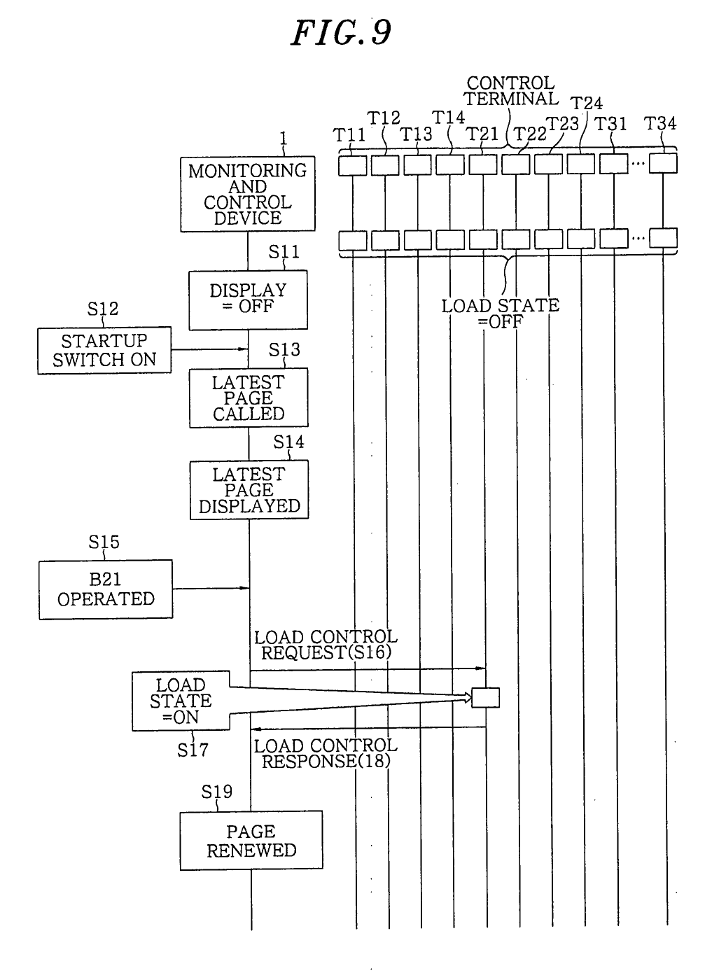

The operation of the monitoring and control device 1 in accordance with the second embodiment will now be described with reference to the sequence diagram shown in FIG. 9. Illustrated herein is the operation for turning off the load L21 after the load L21 has been turned on through the process shown in FIG. 8 and described in respect of the first embodiment.

If the auto-off time is lapsed with the touch switch panel 3 and the startup switch 9 kept inoperative after operation of the operation button B21, the control unit 10 causes the page information storage unit 19 to store the operation page P2 as the final display page and then turns off the screen display of the display panel 2 (step S11).

If the startup switch 9 is pressed thereafter (step S12), the control unit 10 reads out the operation page P2 as the final display page from the page information storage unit 19 (step S13) and resumes the screen display of the display panel 2 to display the operation page P2 (as illustrated in FIG. 8) (step S14). Therefore, the user can operate the operation button B21 (step S15) without having to change over the operation page to turn off the load L21 after resumption of the screen display. This enables the monitoring and control device 1 to perform a series of steps (steps S16 through S19) for turning off the load L21.

With the configuration set forth above, the screen display is resumed from one of the operation pages P1, P2 and P3 that was displayed on the display panel 2 immediately before turning off the screen display. After resumption of the screen display, it is possible for the user to restart an operation in the state available prior to the interruption of the screen display. In case where the user temporarily leaves the monitoring and control device 1 and subsequently wishes to perform an operation in the state available prior to the interruption of the screen display, there is no need to change over the operation pages P1, P2 and P3. This provides an advantage in that the operability is proportionately improved as compared to a case where the screen display is resumed from one of the operation pages P1, P2 and P3 fixed as an initial screen page.

As a modified example of the present embodiment, it may be thought that one of the operation pages P1, P2 and P3 to be displayed as the top page at the time of resuming the screen display is preliminarily set by the user's operation. In this case, the page determination unit 15 ensures that one of the operation pages P1, P2 and P3 arbitrarily selected by the user in the setting mode is stored as a registered page in the page information storage unit 19. The page determination unit 15 allows the registered page to be displayed as the top page at the time of resuming the screen display.

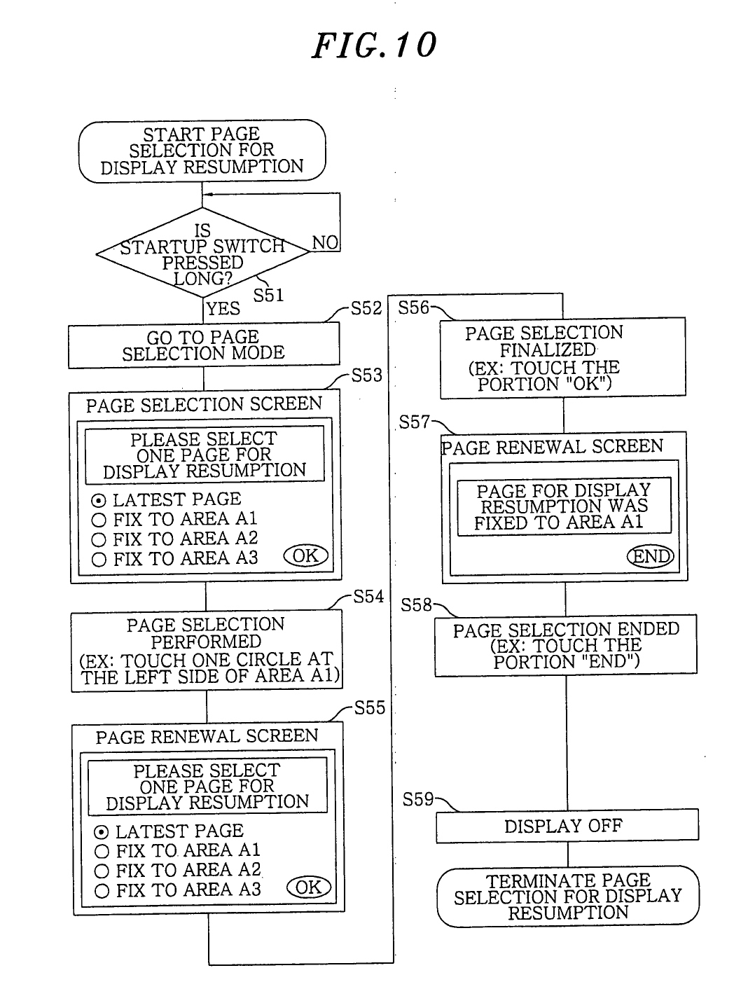

Next, a process for selecting the registered page will be described with reference to the flowchart illustrated in FIG. 10.

If the startup switch 9 is pressed long in the operation mode (or if yes in step S51), the control unit 10 converts the operation mode to the setting mode. If a registered page selection mode (or a screen selection mode available at the time of display resumption) is selected (step S52), the control unit 10 causes the display panel 2 to display a registered page selection screen (shown inside the frame of step S53 in FIG. 10 (step S53). On this selection screen, the user performs an operation by which to select a desired one of the operation pages P1, P2 and P3 as the registered page (step S54). In this regard, it is assumed that the circle displayed at the left side of the item reading “FIX TO AREA A1” has been touched in order to set, as the registered page, the operation page P1 containing the operation buttons B11 through B14 corresponding to the loads L11 through L14 arranged within the installation area A1. Likewise, the item reading “FIX TO AREA A2” may be selected to choose the operation page P2, and the item reading “FIX TO AREA A3” may be selected to choose the operation page P3.

If the operation page P1 is selected, the control unit 10 renews the display content of the display panel 2 into the selection screen reflecting the selected content (namely, the screen shown inside the frame of S55 in FIG. 10) (step S55). If the icon reading “OK” displayed at the right lower side of the selection screen is touched in this state (step S56), the display content of the display panel 2 is renewed into the screen (namely, the screen shown inside the frame of step S57 in FIG. 10) indicating that the operation page P1 has been set as the registered page (step S57). If the icon reading “END” displayed at the right lower side of this screen is touched (step S58), the screen display of the display panel 2 is turned off (step S59), thereby terminating the setting mode.

The registered page selection screen illustrated in FIG. 10 contains an item reading “LATEST PAGE”. If this item is selected, the latest display page mentioned above is displayed as the top page at the time of resuming the screen display.

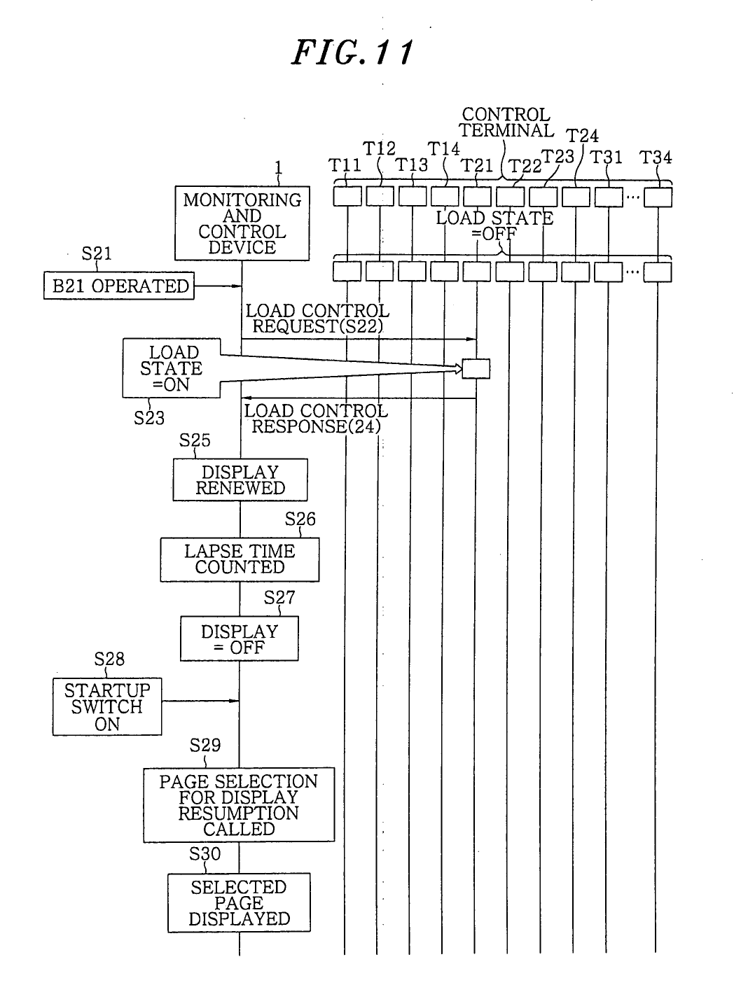

Next, the operation of the monitoring and control device 1 in case of the operation page P1 being selected as the registered page will be described with reference to the sequence diagram illustrated in FIG. 11.

If the operation button B21 is operated by the user while the loads L are all in an off-state (step S21), the monitoring and control device 1 performs a series of steps S22 through S25 for turning on the load L21. If the auto-off time is lapsed with the touch switch panel 3 and the startup switch 9 kept inoperative after operation of the operation button B21 (step S26), the control unit 10 turns off the screen display of the display panel 2 (step S27). Thereafter, if the startup switch 9 is pressed (step S28), the control unit 10 reads out the operation page P1 as the registered page from the page information storage unit 19 (step S29) and resumes the screen display of the display panel 2 to display the operation page P1 (as illustrated in Fig. FIG. 1A) (step S30).

With the configuration described above, the screen display is resumed from an arbitrary specific one of the operation pages P1, P2 and P3 (namely, the registered page) regardless of which one of the operation pages P1, P2 and P3 was displayed on the display panel 2 immediately before the screen display is turned off. This enables the user to operate the operation buttons B of the registered page immediately after resumption of the screen display. Therefore, if one of the operation pages P1, P2 and P3 containing the operation buttons B frequently used by the user is set as the registered page, there is no need to change over the operation pages P1, P2 and P3 when the operation buttons B are operated after resumption of the screen display. This provides an advantage in that the operability is proportionately improved as compared to a case where the screen display is resumed from one of the operation pages P1, P2 and P3 which was displayed on the display panel 2 before interruption of the screen display.

Other configurations and functions of the present embodiment remain the same as those of the first embodiment.

### Third Embodiment

The monitoring and control device 1 of the present embodiment differs from that of the second embodiment in that the control unit 10 includes a counter unit (not shown) for counting the operation frequency of the operation buttons B and a page renewal unit (not shown) for changing the arrangement of the operation buttons B on the respective operation pages P1, P2 and P3.

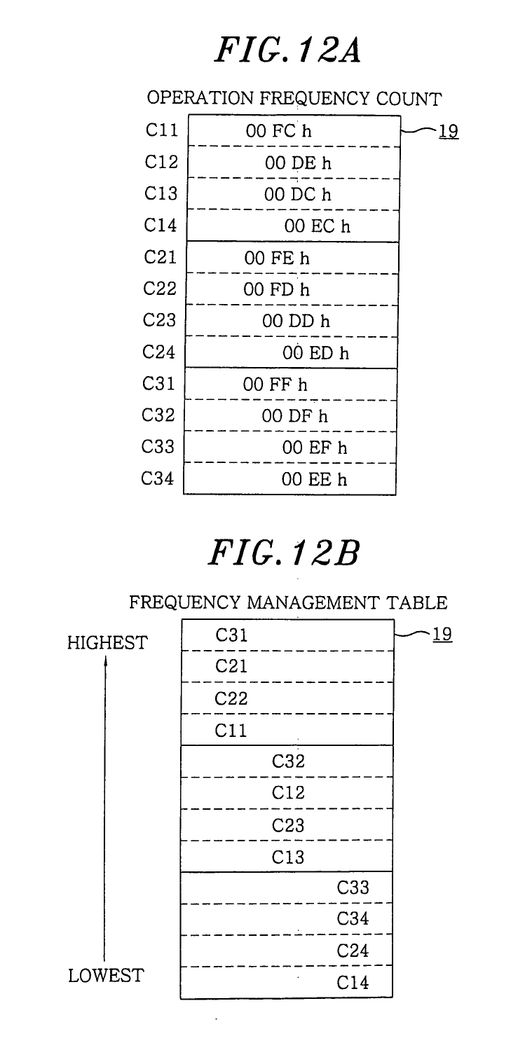

The counter unit is configured to count the touch operation frequency of each of the operation buttons B displayable on the display panel 2. The counter unit normally performs the processing by which, as shown in FIG. 12A, the counter values C11 through C14, C21 through C24 and C31 through C34 corresponding to the operation buttons B11 through B14, B21 through B24 and B31 through B34 are increased by one and stored in an operation frequency counter 18 each time the operation buttons B11 through B14, B21 through B24 and B31 through B34 are operated. In the following description, the counter values C11 through C14, C21 through C24 and C31 through C34 will be simply referred to as “counter values C” if there is no need to distinguish them from one another. The operation frequencies of the operation buttons B are counted as individual counter values C.

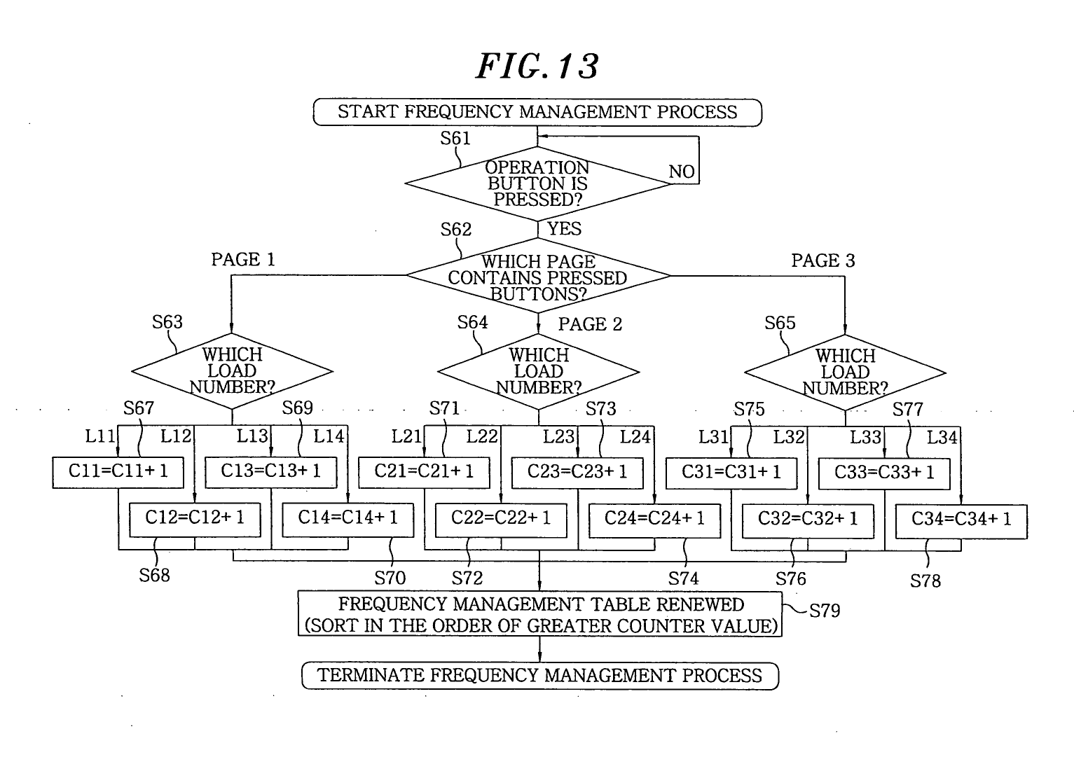

When the screen display is resumed by the display resumption unit 14, the page renewal unit determines the display positions of the operation buttons B based on the magnitude relation between the counter values C of the counter unit. More specifically, if the startup switch 9 is pressed while the screen display is in an off-state, the page renewal unit performs the processing by which the counter values C at that time are rearranged in an ascending order or a descending order. The results of rearrangement are stored in a frequency management table 19 as illustrated in FIG. 13B. The page renewal unit rearranges the operation buttons B based on the content of the frequency management table 19, thus restructuring the operation pages P1, P2 and P3.

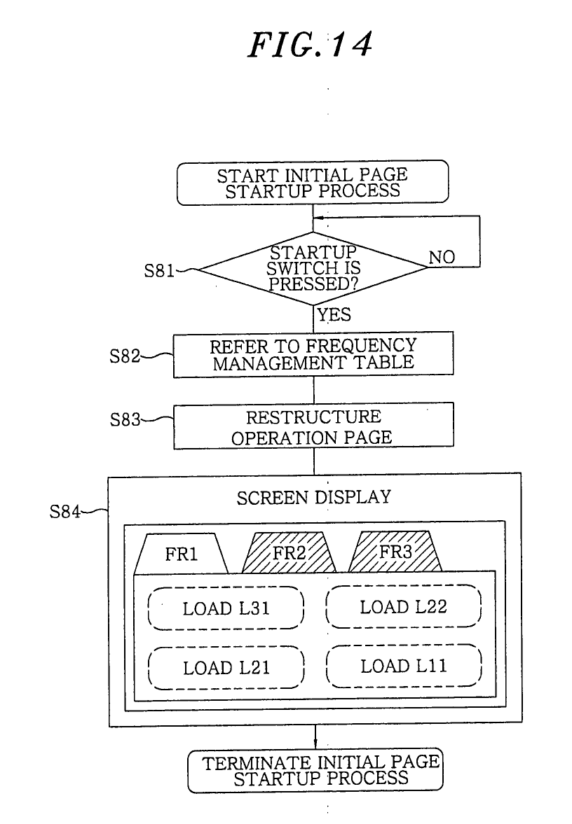

The monitoring and control device 1 of the present embodiment works as follows. Referring to FIG. 13, if the operation buttons B are operated (step S61), the control unit 10 specifies the operation pages P1, P2 and P3 containing the operation buttons B (step S62). After the operation buttons B are specified (steps S62 through S65), the control unit 10 increases the corresponding counter values C by one (steps S67 through S78) and renews the frequency management table 19 based on the counter values C thus changed (step S79). Referring to FIG. 14, if the startup switch 9 is pressed (if yes in step S81) while the screen display is in an off-state, the page renewal unit refers to the frequency management table 19 (step S82) and performs the processing by which to restructure the operation pages P1, P2 and P3 (step S83). As a result, the screen having the operation buttons B rearranged (e.g., the screen shown inside the frame of S84 in FIG. 14). Is displayed on the display panel 2 (step S84).

More specifically, the page renewal unit performs rearrangement of the operation buttons B by comparing the operation frequencies (or the counter values C) of all the operation buttons B regardless of the installation areas A1, A2 and A3 of the loads L corresponding to the operation buttons B. The page renewal unit distributes the operation buttons B on the three operation pages P1, P2 and P3 depending on the operation frequencies. At this time, the operation page P1 is set as the top page to be initially displayed at the time of resuming the screen display. The operation buttons B having increased operation frequencies are arranged four by four in the order of the operation pages P1, P2 and P3. In a nutshell, the operation page P1 as the top page is composed of the four operation buttons B having the greatest counter values C (namely, the highest operation frequencies). The operation page P2 is composed of the four operation buttons B having the second greatest counter values C. The operation page P3 is composed of the remaining four operation buttons B.

The page renewal unit determines the arrangement of the operation buttons B in the respective operation pages P1, P2 and P3 so that the operation buttons B can be arranged in the left upper portion, the left lower portion, the right upper portion and the right lower portion of each of the operation pages P1, P2 and P3 in the order of the magnitude of the counter values C. This means that the operation button B having the greatest operation frequency (namely, the operation button B having the greatest counter value C) is arranged in the left upper portion of the operation page P1.

For example, if the counter value C31 corresponding to the operation button B31 becomes greatest (“00 FF h”=255) and the counter value C14 corresponding to the operation button B14 becomes smallest (“00 EC h”=236) as illustrated in FIG. 12A, the counter values C in the frequency management table 19 are rearranged as shown in FIG. 12B. As a result, the operation buttons B31, B21, B22 and B11 corresponding to the loads L31, L21, L22 and L11 are arranged in the operation page P1. The operation buttons B32, B12, B23 and B13 corresponding to the loads L32, L12, L23 and L13 are arranged in the operation page P2. Similarly, the operation buttons B33, B34, B24 and B14 corresponding to the loads L33, L34, L24 and L14 are arranged in the operation page P3.

With the configuration described above, the operation buttons B are automatically rearranged in the order of higher operation frequencies and the operation buttons B having the highest operation frequencies are displayed on the operation page P1 as the top page. Therefore, after resumption of the screen display, it is not necessary for the user to change over the operation pages P1, P2 and P3 in order to operate the operation buttons B having the highest operation frequencies. This provides an advantage of enhanced operability.

Alternatively, an icon reading “SORT” may be displayed on the screen of the display panel 2 so that, by touching the icon, the operation pages P1, P2 and P3 divided on the operation frequency basis can be changed to the original operation pages P1, P2 and P3 (namely, the operation pages in which the operation buttons B are sorted according to the installation areas A1, A2 and A3 of the corresponding loads L).

Other configurations and functions of the present embodiment remain the same as those of the second embodiment.

The monitoring and control device 1 of the present invention can be used not only in the remote monitoring and control system that performs direct communications between the monitoring and control device 1 and the control terminals T but also in the remote monitoring and control system provided with the transmission unit as the central unit as described in the section of Background of the Invention. In this case, individual addresses are allocated to the respective operation buttons B serving as the switches of the monitoring and control device 1. The addresses of the operation buttons B and the addresses of the control terminals T are mated by the control table stored in the transmission unit. In the monitoring and control device 1, individual load numbers are assigned to the respective operation buttons B. The specific addresses of the monitoring and control device 1 followed by the load numbers are used as the addresses of the respective operation buttons B.

### Fourth Embodiment

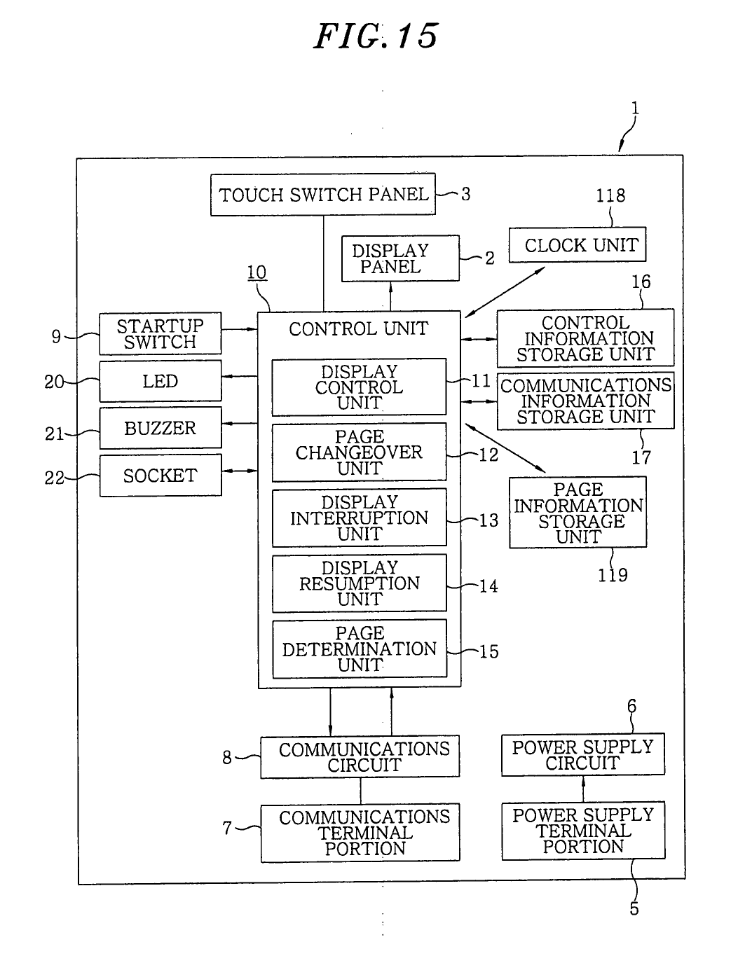

The monitoring and control device 1 of the present embodiment differs from that of the second embodiment in that, as shown in FIG. 15, the control unit 10 further includes a clock unit 118 for acquiring clock information indicative of the current and the page information storage unit 119, which stores a schedule table in which the operation pages P1, P2 and P3 preliminarily designated as designated pages on a time zone basis are mated with the time zones.

At the time of resuming the screen display, the page determination unit 15 refers to the schedule table and initially displays the designated page corresponding to the time zone to which the resumption time point belongs. By individually selecting the operation pages P1, P2 and P3 having higher operation frequencies on a time zone basis and setting the selected operation pages as the designated pages, it becomes possible to resume the screen display from the operation pages P1, P2 and P3 having higher operation frequencies in the respective time zones even when the operation pages P1, P2 and P3 having higher operation frequencies are changed depending on the time zones. The designated pages corresponding to the respective time zones in the schedule table are arbitrarily set by the user's operation in the setting mode.

More specifically, a day (of 24 hours) is divided into three time zones, namely a morning time zone of from 6:00 to 8:59, a day time zone of from 9:00 to 17:59 and a night time zone of from 18:00 to 5:59. A schedule table, in which designated pages are set for the respective time zones (i.e., the morning time zone, the day time zone and the night time zone), is stored in the page information storage unit 119. As an example, it is assumed that the loads L11 through L14 within the installation area A1 are frequently operated in the morning time zone, the loads L21 through L24 within the installation area A2 being frequently operated in the day time zone, the loads L31 through L34 within the installation area A3 being frequently operated in the night time zone. Under this assumption, the operation page P1 containing the operation buttons B11 through B14 is used as a designated page for the morning time zone, the operation page P2 containing the operation buttons B21 through B24 being used as a designated page for the day time zone, the operation page P3 containing the operation buttons B31 through B34 being used as a designated page for the night time zone.

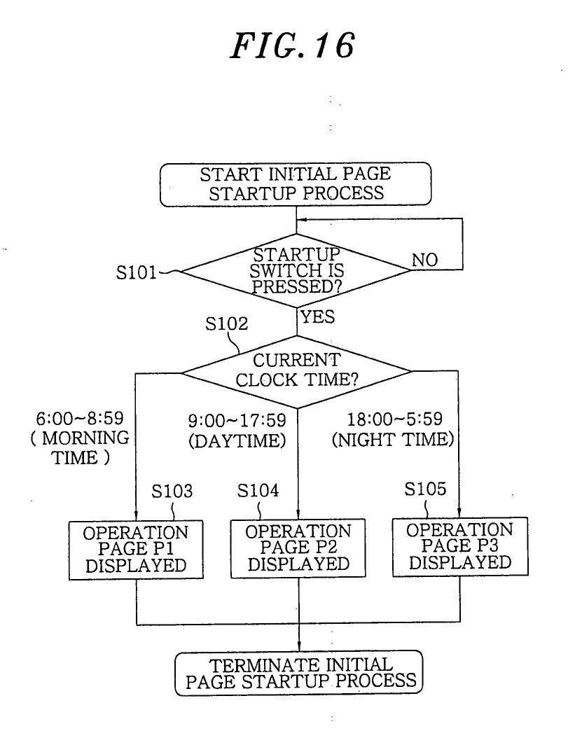

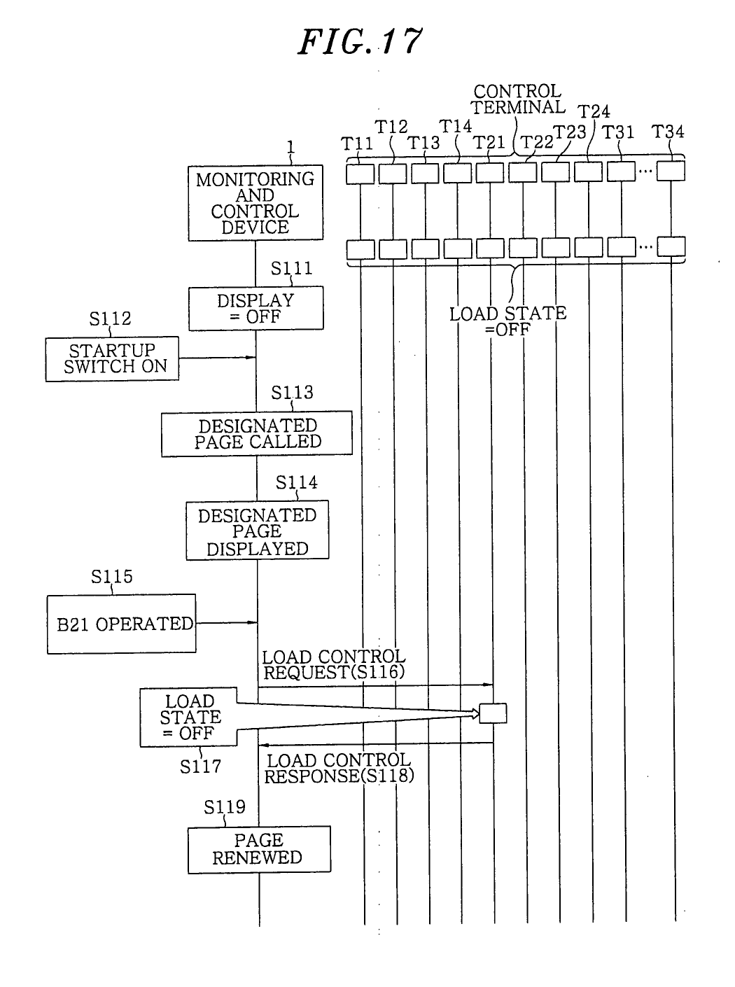

Referring to FIG. 16, if the startup switch 9 is pressed (or if yes in step S101) while the screen display is in an off-state, the control unit 10 acquires clock information indicative of the current hour from a clock unit 118 and determines which one of the morning time zone of from 6:00 to 8:59, the day time zone of from 9:00 to 17:59 and the night time zone of from 18:00 to 5:59 the current hour belongs to (step S102). At this time, if the current hour belongs to the morning time zone, the operation page P1 shown in FIG. 1A is initially displayed at the time of resuming the screen display (step S103). If the current hour belongs to the day time zone, the operation page P2 shown in FIG. 1B is initially displayed (step S104). If the current hour belongs to the night time zone, the operation page P3 shown in FIG. 1C is initially displayed (step S105).

Next, the operation of the monitoring and control device 1 in accordance with the present embodiment will be described with reference to the sequence diagram illustrated in FIG. 17. Illustrated herein is the operation for turning off the load L21 in the day time zone in which the loads L21 through L24 within the installation area A2 are frequently operated.

If the auto-off time is lapsed with the touch switch panel 3 and the startup switch 9 kept inoperative, the control unit 10 turns off the screen display of the display panel 2 (step S111). Thereafter, if the startup switch 9 is pressed (step S112), the control unit 10 reads out from the page information storage unit 119 the operation page P2 as the designated page corresponding to the time zone (of from 9:00 to 17:59) to which the current hour belongs (step S113). Then, the screen display of the display panel 2 is resumed to display the operation page P2 as illustrated in FIG. 7 (step S114).

If the operation button B21 corresponding to the load L21 is touched (step S115) while the operation page P2 is displayed on the display panel 2, a load control request is transmitted from the monitoring and control device 1 to the control terminal T21 (step S116). Upon receiving the load control request, the control terminal T21 analyzes the communications command (namely, the load control request) thus received and recognizes the load control request. At this time point, the control terminal T21 controls the power control circuit 34 thereof so that the load L21 can be turned on according to the control content (step S117). Subsequently, the control terminal T21 returns to the monitoring and control device 1a load control response indicating that the load L21 is in an on-state (step S118).

Responsive to the load control response, the monitoring and control device 1 analyzes the communications command (namely, the load control response) thus received and recognizes the load control response. At this time point, the monitoring and control device 1 changes the display state of the operation button B21 corresponding to the load L21 according to the control content so that the screen page shown in FIG. 7 can be displayed on the display panel 2 (step S119). This makes it possible to notify the user of the change in the operation state of the load L21.

Therefore, the user can operate the operation button B21 without having to change over the operation pages P1, P2 and P3 to turn off the load L21 after resumption of the screen display. This enables the monitoring and control device 1 to perform a series of steps (steps S116 through S119) for turning off the load L21.

With the monitoring and control device 1 described above, the operation buttons B corresponding to the respective loads L are divisionally displayed on the operation pages P1, P2 and P3. This makes it possible to reduce the number of operation buttons B to be displayed on one screen page. At the time of resuming the screen display, it is possible to initially display one of the operation pages P1, P2 and P3 preliminarily designated on a time zone basis.

In case where the user's behavior patterns are changed depending on the time zones and in case where the operation pages P1, P2 and P3 having higher operation frequencies varies with the time zones, the time required in changing over the operation pages P1, P2 and P3 after resumption of the screen display can be reduced by preliminarily setting the operation pages P1, P2 and P3 having higher operation frequencies as the designated pages. In other words, there is no need to change over the operation pages P1, P2 and P3 in order to operate the operation buttons B having higher operation frequencies after resumption of the screen display. The operation buttons B can be operated immediately after resumption of the screen display. This helps enhance the operability.

Although the time zones of the schedule table are divided into the morning time zone, the day time zone and the night time zone in the present embodiment, they may be arbitrarily defined within a day (of 24 hours). The rule of dividing the time zones is not limited to the example set forth above. Instead of repeatedly using the schedule table of the same content in a one-day cycle, it may be possible to change the content of the schedule table day by day.

Other configurations and functions of the present embodiment remain the same as those of the second embodiment.

### Fifth Embodiment

The monitoring and control device 1 of the present embodiment differs from that of the fourth embodiment in that the time zones of the schedule table are defined in a one-week cycle and on a day-by-day basis.

More specifically, a week is divided into three time periods, namely a workday period (ranging from Monday to Friday), a Saturday period and a Sunday period. The respective periods (namely, the workday period, the Saturday period and the Sunday period) are employed as the time zones in the schedule table. As an example, it is assumed that the loads L11 through L14 within the installation area A1 are frequently operated in the workday period, the loads L21 through L24 within the installation area A2 being frequently operated in the Saturday period, the loads L31 through L34 within the installation area A3 being frequently operated in the Sunday period.

Under this assumption, the operation page P1 containing the operation buttons B11 through B14 is used as a designated page for the workday period, the operation page P2 containing the operation buttons B21 through B24 being used as a designated page for the Saturday period, the operation page P3 containing the operation buttons B31 through B34 being used as a designated page for the Sunday period. In this regard, the control unit 10 can acquire from the clock unit 18 not only the clock information but also the week day information indicative of the day of the week.

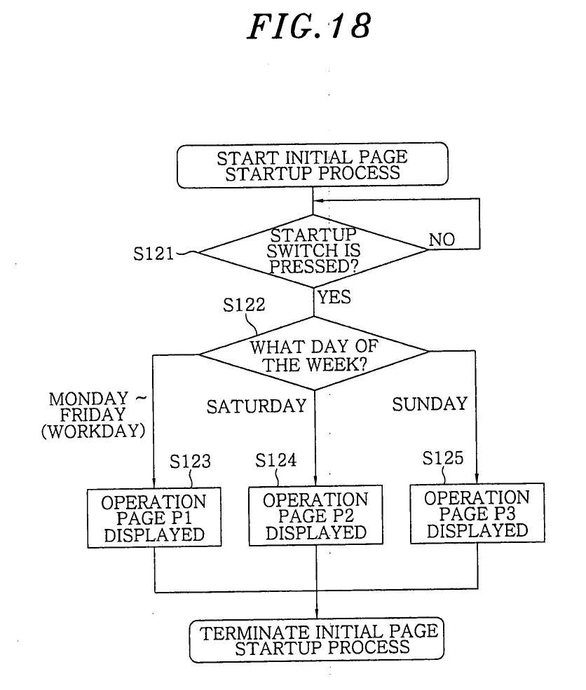

Referring to FIG. 18, if the startup switch 9 is pressed (or if yes in step S121) while the screen display is in an off-state, the control unit 10 acquires week day information indicative of the day of the week from the clock unit 18 and determines which one of the workday period, the Saturday period and the Sunday period the present day belongs to (step S122). At this time, if the present day belongs to the workday period, the operation page P1 shown in FIG. 1A is initially displayed at the time of resuming the screen display (step S123). If the present day belongs to the Saturday period, the operation page P2 shown in FIG. 1B is initially displayed (step S124). If the present day belongs to the Sunday period, the operation page P3 shown in FIG. 1C is initially displayed (step S125).

With the configuration described above, the operation pages P1, P2 and P3 to be initially displayed on the display panel 2 at the time of resuming the screen display can be preliminarily designated on a week day time zone basis. In case where the user's behavior patterns are changed depending on the week days and in case where the operation pages P1, P2 and P3 having higher operation frequencies varies with the week days, the time required in changing over the operation pages P1, P2 and P3 after resumption of the screen display can be reduced by preliminarily setting the operation pages P1, P2 and P3 having higher operation frequencies as the designated pages for the week days.

Although the time zones of the schedule table are divided into the workday period, the Saturday period and the Sunday period in the present embodiment, they may be arbitrarily defined in a one-week cycle and on a day-by-day basis. The rule of dividing the time zones is not limited to the example set forth above. As an alternative example, the schedule table may be set by dividing each day of a week into a plurality of time zones as in the fourth embodiment. Then, the schedule table may be repeatedly used in a one-week cycle.

Other configurations and functions of the present embodiment remain the same as those of the fourth embodiment.

The monitoring and control device 1 of the present invention can be used not only in the remote monitoring and control system that performs direct communications between the monitoring and control device 1 and the control terminals T but also in the remote monitoring and control system provided with the transmission unit as the central unit as described in the section of Background of the Invention. In this case, individual addresses are allocated to the respective operation buttons B serving as the switches of the monitoring and control device 1. The addresses of the operation buttons B and the addresses of the control terminals T are mated by the control table stored in the transmission unit. In the monitoring and control device 1, individual load numbers are assigned to the respective operation buttons B. The specific addresses of the monitoring and control device 1 followed by the load numbers are used as the addresses of the respective operation buttons B.

The time zones of the schedule table are not limited the one-day based time zones described in respect of the fourth embodiment or the one-week based time zones described in connection with the fifth embodiment. As an alternative example, the time zones of the schedule table may be defined in a one-year (12-month) cycle and on a season-by-season basis.

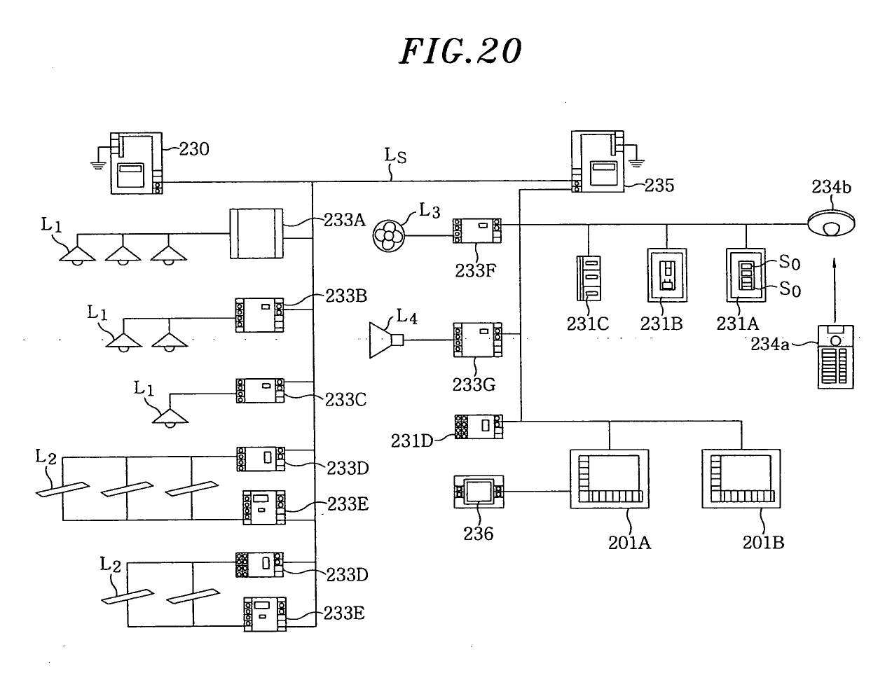

The monitoring and control devices to be described in respect of the following embodiments are used in the remote monitoring and control system shown in FIG. 20. The basic configuration of this system remains the same as that of the remote monitoring and control system described earlier in the section of Background of the Invention.

More specifically, the remote monitoring and control system shown in FIG. 20 includes, as the loads L, incandescent lamps L1, fluorescent lamps L2 each having an inverter-type lighting device, a fan coil L3 for an air-conditioner, and a speaker L4. The incandescent lamps L1 are controlled by lamp-dimming control terminals (of 1500 W, 800 W and 500 W) 33A, 33B and 33C, each of which has a capacity corresponding to the number of lamps. The fluorescent lamps L2 are controlled by a control terminal 233D having a relay for controlling lamp on-off operations and a lamp-dimming control terminal 233E used in controlling a light output. The fan coil L3 is controlled by a fan coil control terminal 233F to operate in one of three, weak, middle and strong operation intensity. The volume of the speaker L4 is controlled by a volume control terminal 233G. Other examples of the loads may include an electric curtain, an electric screen and a ventilation fan.

The remote monitoring and control system includes an operation terminal 231A provided with switches S0, a couple of dimming operation terminals 231B and 231c, and a contact point input operation terminal 231D to which various kinds of sensors capable of producing contact point outputs are connected. In addition, it is possible to provide an additional operation terminal by combining a wireless transmitter 234a having an operation portion with a wireless receiver 234b. In the illustrated example, a repeater (or an amplifier) 235 is arranged on a signal line Ls so that a transmission signal can be transmitted with no attenuation. In the illustrated example, two monitoring and control devices 201A and 201B serving as operation terminals are connected to the remote monitoring and control system. Hereinafter, the monitoring and control devices 201A and 201B will be simply referred to as “monitoring and control device 201” if there is no need to distinguish them from each other. The monitoring and control device 201A is supplied with electric power of AC 24V from a remote-controlled transformer 236, i.e., a voltage-dropping transformer, for dropping the voltage of commercial power (of, e.g., AC 100V) and outputting electric power of reduced voltage. In the following description, the operation terminals 201A, 201B and 231A through 231D will be simply referred to as “operation terminal 231” if there is no need to distinguish them from one another. Likewise, the control terminals 233A through 233G will be simply referred to as “control terminal 233” if there is no need to distinguish them from each other.

The remote monitoring and control system further includes a transmission unit 230 for periodically sending a transmission signal through the signal line Ls. Used as the transmission signal is, e.g., a bipolar pulse-width-modulation signal of ±24V. In the operation terminals 231 and the control terminals 233 other than the monitoring and control device 201, the transmission signal is full-wave rectified to secure internal electric power. The transmission unit 230 is supplied with commercial power.

The operation terminals 231 and the control terminals 233 are mated with each other by means of addresses. If the mating addresses of the operation side and the control side are set to have an equal value, it becomes possible to figure out the correspondence relation with ease. To this end, a concept of “channel” is used and the addresses of the operation side and the control side in a one-to-one correspondence relation are set to fall within the same channel. Four loads L in the same channel can be controlled by designating load numbers. For example, the expression reading “0-1” signifies the first load L of 0^{th} channel. Each of the operation terminals and each of the control terminals can be mated with a single combination of channel and load number. The control table indicative of the mating relation is preliminarily provided in the transmission unit 230. In the following description, it is assumed that the addresses (namely, the channel plus the load number) in the range of from “0-1” to “63-4” are assigned to the switches and the loads L.

In the control table, the switches and the loads L can be mated with each other not only in a one-to-one correspondence relationship but also in a one-to-multiple correspondence relationship. For example, in case where the remote monitoring and control system turns on or off the electric power to be supplied to the fluorescent lamps L2 as the loads, it is possible for the transmission unit 230 to set individual control by which the fluorescent lamps L2 of a single circuit are turned on or off with a single switch and collective control by which the fluorescent lamps L2 of a plurality of circuits are collectively turned on or off with a single switch. In other words, the individual control means that the loads L belonging to a single circuit are controlled by one instruction, whereas the collective control means that the loads L belonging to a plurality of circuits are controlled by one instruction.

The collective control is divided into group control and pattern control. In the group control, the ranges of the loads L to be controlled are preliminarily mated with the switches, and the loads L belonging to each of the ranges are collectively turned on or off by operating one of the switches. In the pattern control, the ranges of the addresses of the loads L to be controlled and the on-off conditions of the loads L corresponding to the respective addresses are preliminarily mated with the switches, and the loads L belonging to each of the ranges are individually turned on or off by operating one of the switches.

In order to perform the group control or the pattern control set forth above, the group numbers or the pattern numbers corresponding to the switches for performing the group control or the pattern control are mated with the addresses of the loads L to be controlled, in the control table of the transmission unit 230. Upon operating one of the switches for performing the group control or the pattern control, the transmission unit 230 refers to the control table, extracts the addresses of the loads L to be controlled and determines the on-off conditions of the loads L. Thereafter, the transmission unit 230 issues an instruction to the control terminal 233 having the address identified by referring to the control table. In the following description, it is assumed that the addresses (or the group numbers) in the range of from “1” to “127” are assigned to the switches for the group control and further that the addresses (or the pattern numbers) in the range of from “1” to “72” are assigned to the switches for the pattern control.

When one wishes to control the operations of the respective loads L in a place, e.g., a meeting room, where there exists a plurality of loads L, it is necessary to use a plurality of switches. This poses a problem of increasing the space occupied by the operation terminals 231. In this connection, use of the group control or the pattern control makes it possible to control the operation of each of the loads L with a single switch.

Brief description will now be made on the operation of the remote monitoring and control system.

The transmission unit 230 performs normal polling by which a transmission signal carrying terminal addresses changed to cyclic codes is periodically transmitted to the signal line Ls at a normal time. Used as the transmission signal is a bipolar signal that contains a start pulse indicative of the startup of signal transmission, a mode data indicative of a signal mode, an address data carrying a terminal address used in specifically calling the operation terminal 231 or the control terminal 233, a control data (including a load number) for use in controlling the loads L, a checksum data for use in detecting transmission errors, and a data on a response waiting time slot, i.e., a time slot during which a response signal is received from the operation terminal 231 or the control terminal 233.

If a monitoring input is generated in one of the operation terminals 231 through the operation of a switch or other operations, the operation terminal 231 transmits to the signal line Ls an interrupt signal synchronized with the start pulse of the transmission signal. The operation terminal 231 that has generated the interrupt signal comes into a latch state in which an interrupt flag is set. Upon detecting the interrupt signal, the transmission unit 230 transmits a transmission signal whose mode data is set in a search mode. Responsive to the transmission signal of search mode, the operation terminal 231 kept in the latch state returns a terminal address to the transmission unit 230 during the response waiting time slot. Upon receiving the terminal address, the transmission unit 230 sends a transmission signal that requests the operation terminal 231 matched with the terminal address to send back information on the latch state. By confirming the latch state, the transmission unit 230 recognizes the operation terminal 231 that has generated the interrupt signal.

Upon recognizing the operation terminal 231 that has generated the interrupt signal, the transmission unit 230 delivers to the signal line Ls a transmission signal whose mode data is in the monitoring mode and which carries the address thus acquired. Responsive to this transmission signal, the operation terminal 231 returns the necessary information during the response waiting time slot. Finally, the transmission unit 230 sends to the operation terminal 231 a transmission signal for releasing the latch state, thereby releasing the operation terminal 231 from the latch state.

Upon receiving the request from the operation terminal 231 through the operation set forth above, the transmission unit 230 requests the control terminal 233 mated with the operation terminal 231 in the control table to control the load L. Then, the transmission unit 230 sends to the control terminal 233 a transmission signal for determining the status of the load L to be controlled and receives information on the load status from the control terminal 233. The information on the load status received from the control terminal 233 is transmitted from the transmission unit 230 to the operation terminal 231 that has generated the monitoring input. The operation terminal 231 indicates the status of the load to be controlled using an indication lamp or other lamps for indicating an on-off state.

In the remote monitoring and control system described above, if the switch of the operation terminal 231 is operated, the transmission unit 230 collates the address of the switch (i.e., the terminal address+the load number) with the control terminal 233 and sends a transmission signal instructing control of the load L to the control terminal 233 connected to the load L mated with the switch. This operation makes it possible to reflect the on-off information of the switch in the control of the load L.

### Sixth Embodiment

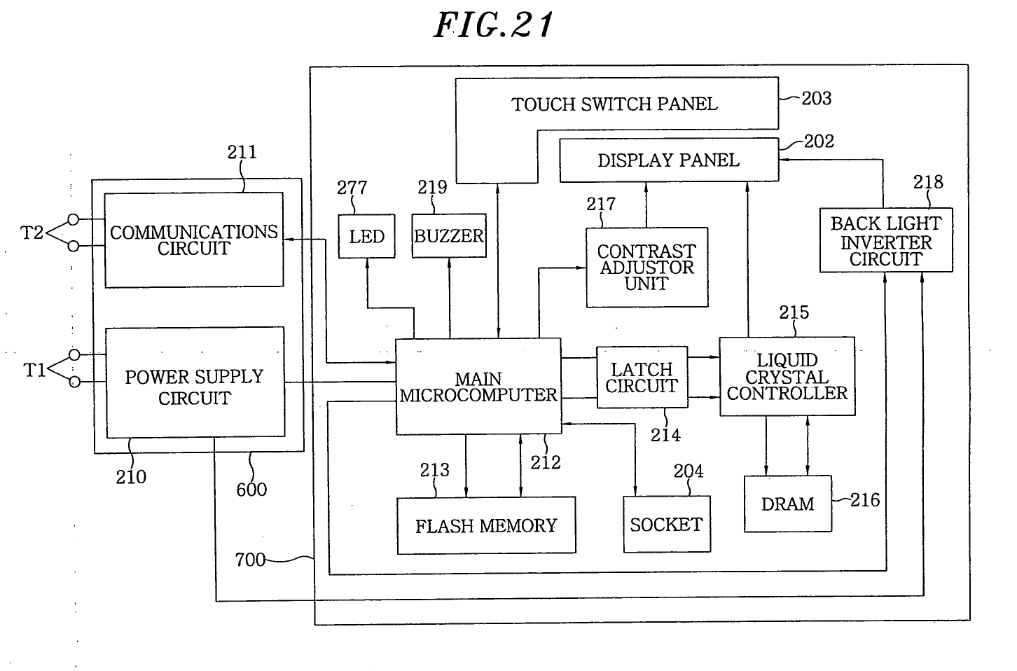

Referring to FIG. 21, the monitoring and control device 201 of the present embodiment includes a display panel 202 formed by combining a backlight with a liquid crystal display device, and a transparent flat touch switch panel 203 superimposed on the screen (or the front surface) of the display panel 202.

The display panel 202 is of a matrix display type in which a multiplicity of pixels is arranged in a matrix pattern along the row and column directions. Figures are represented in color by the combination of pixels. The touch switch panel 203 includes a transparent sheet member and a plurality of transparent electrode contact points arranged on the sheet member. The touch switch panel 203 is a resistance-pressure-sensitive touch switch panel that outputs a signal indicating the point on the sheet member touched by a finger or the like. The display panel 202 and the touch switch panel 203 cooperate to form a touch panel display.

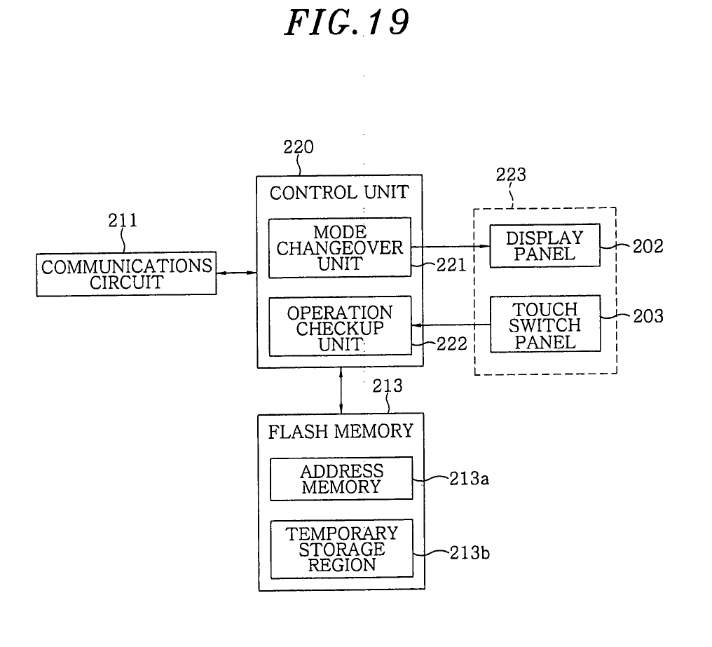

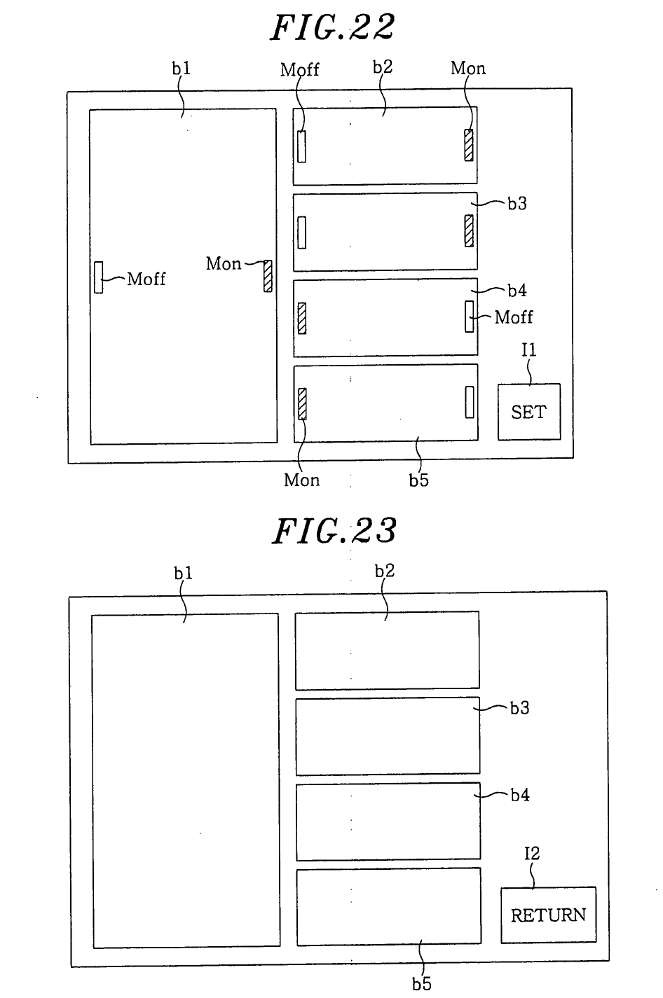

The touch panel display is used as an operation input unit 223 (see FIG. 19) for receiving the user's operation input. The areas of the touch switch panel 203 defined by the operation buttons b1 through b5 (see FIG. 22) displayed on the screen of the display panel 202 are used as switches. Accordingly, the user can touch one of the switches (or the operation buttons b1 through b5) on the screen of the display panel 202 to control the load corresponding to the touched operation button.

Referring to FIG. 21, the monitoring and control device 201 includes a power supply circuit 210 for supplying a direct current to internal circuits and a communications circuit 211 for sending and receiving transmission signals, the communications circuit 211 connected to a signal line Ls which in turn is connected to the transmission unit 230. The communications circuit 211 is connected to a main microcomputer 212 which is a major component of a control unit 220 (see FIG. 19). The main microcomputer 212 is operated according to the program and data stored in a flash memory 213 serving as a built-in memory of the monitoring and control device 201. As will be described later, the flash memory 213 is also used as a memory that stores the addresses (namely, the terminal addresses plus the load numbers) allocated to the respective switches and is provided with a region that stores the addresses (hereinafter referred to as “address memory”). In the flash memory 213, there is also provided a region for copying at least the data of a memory card formed of an SD memory card (registered trademark). The memory card is removably attached to a socket 204.

The main microcomputer 212 outputs the data indicative of the display content of the display panel 202 to a liquid crystal controller 215 through a latch circuit 214. The liquid crystal controller 215 displays a specified content in a predetermined position of the display panel 202 using the data preliminarily registered in a DRAM 216. The contrast of the display panel 202 and the brightness of the backlight are automatically adjusted by a contrast adjustor unit 217 and a backlight inverter circuit 218, both of which are controlled by the main microcomputer 212. The main microcomputer 212 has a function of activating a buzzer 219 in response to the operation of the touch switch panel 203.

Referring again to FIG. 19, the control unit 220 of the present monitoring and control device 201 includes a mode changeover unit 221 for changing over two active modes, namely an operation mode in which a transmission signal containing an address is delivered to the signal line Ls in response to the operation of the switches of the operation input unit 223 and an address-setting mode in which the addresses to be stored in the flash memory (or the address memory) 213. In FIG. 19, the main microcomputer 212 and the peripheral circuits thereof are shown to be the control unit 220. The component parts having nothing to do with the following description are not illustrated in FIG. 19.

In other words, the control unit 220 is operable in at least two active modes, namely the operation mode and the address-setting mode, which can be changed over by the mode changeover unit 221 in response to the operation input from the operation input unit 223. Description will now be made on the operations of the control unit 220 in the operation mode and the address-setting mode.

In the operation mode, the control unit 220 causes the display panel 202 to display the load state (or the operation state of the loads) acquired from the communications circuit 211. Furthermore, the control unit 220 performs load control in response to the operation of the touch switch panel 203 associated with the display content. In other words, the display panel 202 serves as a state display unit for displaying the current operation state of the loads to be monitored and controlled. It is therefore possible for the user to control the loads by operating the touch switch panel 203 with reference to the load state display content.

More specifically, in the operation mode, the control unit 220 causes the display panel 202 to display a screen page containing a plurality of operation buttons b1 through b5 as illustrated in FIG. 22. The areas of the touch switch panel 203 overlapping with the operation buttons b1 through b5 on the screen page of the display panel 202 are used as switches. The user can apply operation inputs for the load control by touching the switches of the touch switch panel 203 (i.e., the portions of the touch switch panel 203 corresponding to the operation buttons b1 through b5). In response, the address corresponding to the switch operated by the user in the addresses stored in the address memory 213a of the flash memory 213 is included in a transmission signal, and the transmission signal is delivered to the signal line Ls. By operating the switch corresponding to an arbitrary one of the operation buttons b1 through b5, it is possible to control the load corresponding to the switch operated.

On the operation page, each of the operation buttons b1 through b5 indicates the operation state of the corresponding load. When the load is in an off-state, the off-mark Moff arranged at the left end is turned on in green to indicate the off-state. When the load is in an on-state, the on-mark Mon arranged at the right end is turned on in red to indicate the on-state.

An icon I1 reading “SET” is displayed in the right lower portion of the operation page. The area of the touch switch panel 203 corresponding to the icon I1 serves as a setting switch for executing the address-setting mode. If the setting switch is operated, the operation mode of the control unit 220 is converted to the address-setting mode by the mode changeover unit 221.

If the address-setting mode becomes available, the control unit 220 causes the communications circuit 211 to stop communications with the transmission unit 230 and allows the screen of the display panel 202 to display a selection page containing the operation buttons b1 through b5 as illustrated in FIG. 23. The load operation state (namely, the on-mark Mon and the off-mark Moff) is not displayed on the selection page. Therefore, it is impossible to perform the load control in the address-setting mode, unlike the operation mode in which the load control can be performed by operating the touch switch panel 203.

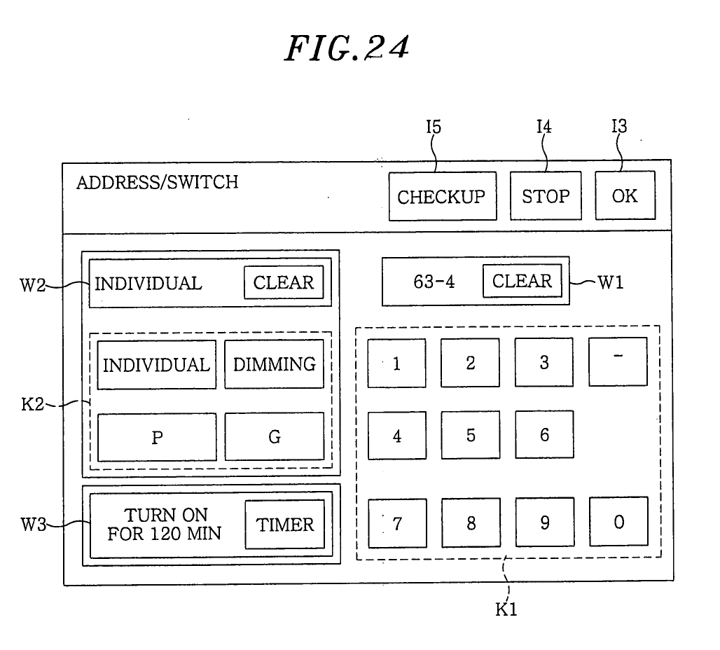

On this selection page, the user can select one address-setting switch by touching each of the switches of the touch switch panel 203 (namely, each of the portions corresponding to the operation buttons b1 through b5). If one address-setting switch is selected, a setting page for setting the address of the selected switch is displayed as illustrated in FIG. 24. The following description will be directed to an instance where the selection switch corresponding to the operation button b is selected. An icon I2 reading “RETURN” is displayed on the right lower portion of the operation page. If the icon I2 is touched, the address-setting mode is converted to the operation mode by the mode changeover unit 221.

On the setting page illustrated in FIG. 24, there is displayed a numerical keypad group K1 by which to set the address of the switch selected from the selection page (namely, the switch corresponding to the operation button b2. The numerical keypad group K1 is composed of a ‘0 ’ key through a ‘9 ’ key and a ‘-’ key. The address can be designated by touching the numerical keypad group K1. The address designated by the numerical keypad group K1 (reading “63-4” in the example illustrated in FIG. 24) is displayed in an address display window W1 above the numerical keypad group K1.

At the left side of the numerical keypad group K1 on the setting page illustrated in FIG. 24, there is displayed a kind key group K2 composed of an I-key (or an independent control key), a P-key (or a pattern control key), a G-key (or a group control key) and a D-key (or a dimming control key). The kind key group K2 is used in designating the kind of the address to be set for the switch (e.g., an individual control address or a group control address). The I-key is selected if the switch address to be set is for the individual control. The G-key is selected if the switch address to be set is for the group control. The P-key is selected if the switch address to be set is for the pattern control. The D-key is selected if the switch address to be set is for the dimming control of illumination devices. The kind of the address thus designated (e.g., the kind “I” in the example illustrated in FIG. 24) is displayed in a kind display window W2 above the kind key group K2.

In the example illustrated in FIG. 24, a timer-setting window W3 is arranged below the kind key group K2. A timer function can be added to the switch under setting operation by touching a setting key reading “TIMER” within the timer-setting window W3. That is to say, the monitoring and control device 201 is capable of adding a timer function to each of the switches. For example, a timer function reading “TURNED ON FOR 120 MIN” may be added to one of the switches. In this case, even if the switch is operated in the operation mode to turn on the corresponding load, the same transmission signal as would be available at the time of re-operating the switch is delivered after lapse of 120 minutes, eventually turning off the load.

The address and other items (e.g., the kind of address and the timer function) set in the address-setting mode are stored in a temporary storage region 213b provided within the flash memory 213. The address and other items (including the kind of address) are displayed in the address display window W1 and the kind display window W2 but may be cleared by touching the clearing keys reading “CLEAR”, which are arranged within the address display window W1 and the kind display window W2.

An icon 13 reading “OK” is displayed in the right upper portion of the setting page. If the icon 13 is touched, the address and other items (e.g., the kind of address and the timer function) under setting operation are stored in an address memory 213a of the flash memory 213 by the control unit 220. At this moment, the address and other items under setting operation are cleared from the temporary storage region 213b of the flash memory 213. Once the task of storing the address and other items in the address memory 213a comes to an end, the mode changeover unit 221 terminates the address-setting mode and converts the active mode of the control unit 220 to the operation mode.

If an icon 14 reading “STOP” arranged at the left side of the icon 13 is touched, the mode changeover unit 221 terminates the address-setting mode and converts the active mode of the control unit 220 to the operation mode, without having to storing the address and other items in the address memory 213a. In this case, the address and other items under setting operation are cleared from the temporary storage region 213b. The address and other items registered in the address memory 213a prior to executing the address-setting mode are used as they stand.

The control unit 220 of the present embodiment includes an operation checkup unit 222 for starting an operation checkup mode in which, if a specified operation is performed in the operation input unit 223 during the address-setting mode, the address-setting mode is temporarily stopped and the address (including the kind of address) under setting operation is tentatively used as a provisional address. The control unit 220 resumes the address-setting mode if the operation checkup mode comes to an end.

More specifically, an icon I5 reading “CHECKUP” is arranged at the left side of the icon I4 of the setting page displayed in the address-setting mode. The area of the touch switch panel 203 corresponding to the icon I5 serves as a checkup switch for starting the operation checkup mode. If the checkup switch is touched, the address-setting mode is temporarily stopped and the operation checkup mode is started by the operation checkup unit 222.

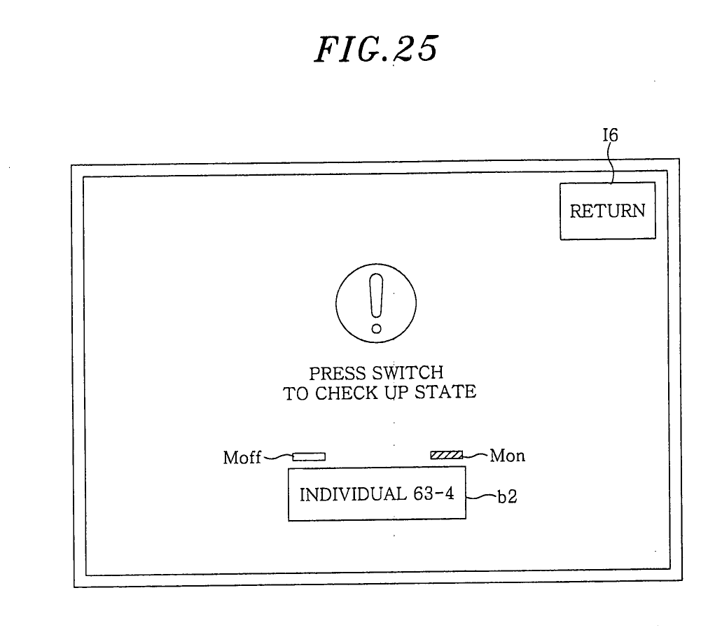

If the operation checkup mode is started, the control unit 220 causes the display panel 202 to display an operation checkup page containing the operation button b2 corresponding to the switch under address-setting operation as illustrated in FIG. 25. If the user touches the switch of the touch switch panel 203 (namely, the portion corresponding to the operation button b2) in this state, the control unit 220 makes communications with the transmission unit 230 through the communications circuit 211 as in the operation mode and performs the load control, at which time the address stored in the temporary storage region 213b of the flash memory 213 is used as the provisional address.

During the communications with the transmission unit 230 in the operation checkup mode, only the address of the switch under setting operation is rendered valid but other addresses stored in the flash memory 213 remain invalid. More specifically, if the address-setting mode is terminated and converted to the operation mode, all addresses stored in the address memory 213a of the flash memory 213 is rendered valid. Therefore, all transmission signals containing these addresses become the subject of transmission and reception. In contrast, only the address of the switch under setting operation stored in the temporary storage region 213b is rendered valid in the operation checkup mode. Therefore, only the transmission signal containing the address under setting operation (namely, the provisional address) becomes the subject of transmission and reception. In the operation checkup mode, therefore, it is possible to check up the operation of the switch under address-setting operation without significantly increasing the burden of communications with the transmission unit 230.

The operation state of the load corresponding to the operation button b2 is displayed on the operation checkup page. In the example illustrated in FIG. 25, the load state is displayed by an off-mark Moff and an on-mark Mon as in the operation mode. The off-mark Moff and the on-mark Mon are not displayed inside the operation button b2 but displayed above the operation button b2. On the operation checkup page illustrated in FIG. 25, the address “63-4” under setting operation is displayed inside the operation button b2.

An icon I6 reading “RETURN” is displayed in the right upper portion of the operation checkup page. If the icon I6 is touched, the operation checkup unit 222 terminates the operation checkup mode. At this time, the control unit 220 resumes the address-setting mode from the state which was available immediately prior to starting the operation checkup mode.

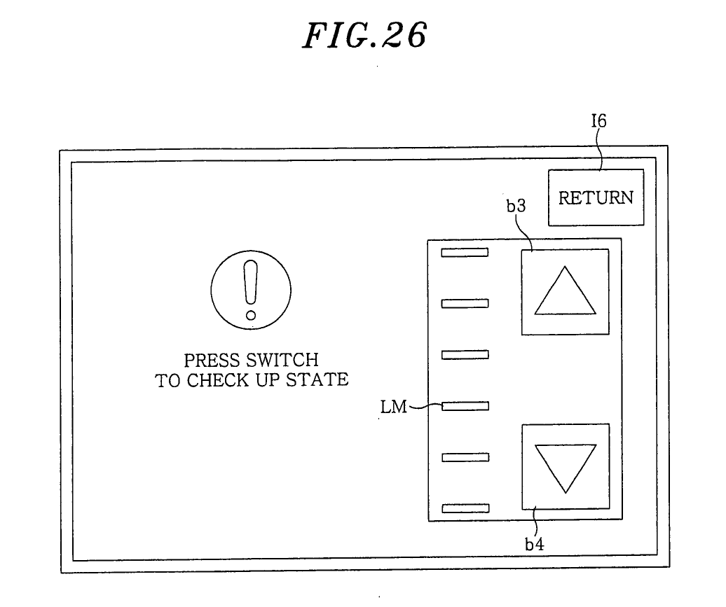

In case where the dimming (or the D-key) is selected as the kind of address of the switch under setting operation, the control unit 220 causes the display panel 2 to display the operation checkup page as illustrated in FIG. 26 in place of the operation checkup page shown in FIG. 25. On the operation checkup page illustrated in FIG. 26, a level meter LM indicating the dimming level of the corresponding illumination device by the number of on-state bars is displayed at the left side of the operation buttons b3 and b4 corresponding to the switch under address-setting operation. The load state is indicated by the level meter LM.

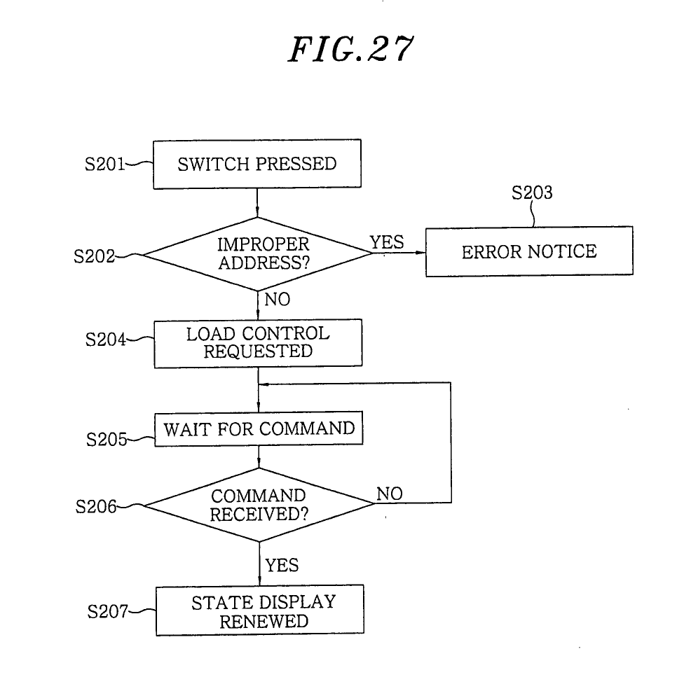

Next, the operation of the monitoring and control device 201 will be described with reference to FIG. 27, which illustrates the processing flow of the control unit 220 in the operation checkup mode.

If the switch on the operation checkup page is pressed (step S201), the control unit 220 checks up whether the address stored in the temporary storage region 213b of the flash memory 213 is improper (e.g., whether the address is set beyond a permissible range) (step S202). If the address is improper, the display panel 2 displays an error notice (step S203).

If not improper, a transmission signal containing the address stored in the temporary storage region 213b is delivered to the signal line Ls, thereby making a request for control of the load corresponding to the address (step S204). Thereafter, the control unit 220 waits for reception of a state display command indicative of the operation state of the load (step S205). Upon receiving the state display command (step S206), the control unit 220 renews the load state display on the operation checkup page according to the state display command (step S207).

With the monitoring and control device 201 described above, the operation checkup mode can be temporarily started by the operation checkup unit 222 and the load control can be attempted with the address under setting operation, while operating the control unit 220 in the address-setting mode. Therefore, the correctness of the address under setting operation can be checked up by checking the operation state of the load. In case where the address is set in error, it is possible to immediately correct the address by terminating the operation checkup mode and resuming the address-setting mode. Consequently, it becomes possible to reduce the loss of time in the address-setting task. This provides an advantageous effect of enhancing the efficiency of the address-setting task.

In addition, the operation state of the load is displayed on the operation checkup page of the display panel 202. This enables the user to check up the operation state of the load based on the display of the monitoring and control device 201, even when the load corresponding to the address under setting operation is located distant from the monitoring and control device 201. In other words, there is no need for the user to go to the load installation place to check up the operation state of the load. This makes it possible to reduce the time required in checking up the correctness of the address.

### Seventh Embodiment

The monitoring and control device 201 of the present embodiment differs from that of the sixth embodiment in that the control unit 220 includes, as one of the active modes, a display color setting mode in which the user can differently set the display color of the operation buttons b1 through b5 displayed on the operation page (see FIG. 22).

In the present embodiment, if the setting switch on the operation page (the area of the touch switch panel 203 corresponding to the icon I1) is touched in the operation mode, the control unit 220 causes the display panel 202 to display the setting menu page illustrated in FIG. 28 in place of the selection page (see FIG. 23) described in respect of the sixth embodiment.

Icons I7 through I13 mated with different setting menus are displayed on the setting menu page. If one of the icons I7 through I13 is touched, the setting menu corresponding to the touched icon appears on the screen of the display panel 2. For example, if the icon I7 reading “SWITCH ADDRESS” is touched, the mode changeover unit 221 converts the active mode of the control unit 220 to the address-setting mode described in respect of the sixth embodiment and causes the display panel 202 to display the selection page (see FIG. 23). If the icon I9 reading “SWITCH COLOR” is touched, the mode changeover unit 221 converts the active mode of the control unit 220 to the display color setting mode.

An icon I14 reading “END” is displayed in the right upper portion of the setting menu page. If the icon I14 is touched, the control unit 220 comes back to the operation mode, causing the display panel 202 to display the operation page. An icon I15 reading “RETURN” is displayed at the left side of the icon I14. If the icon I15 is touched, the preceding page is displayed on the screen of the display panel 202.

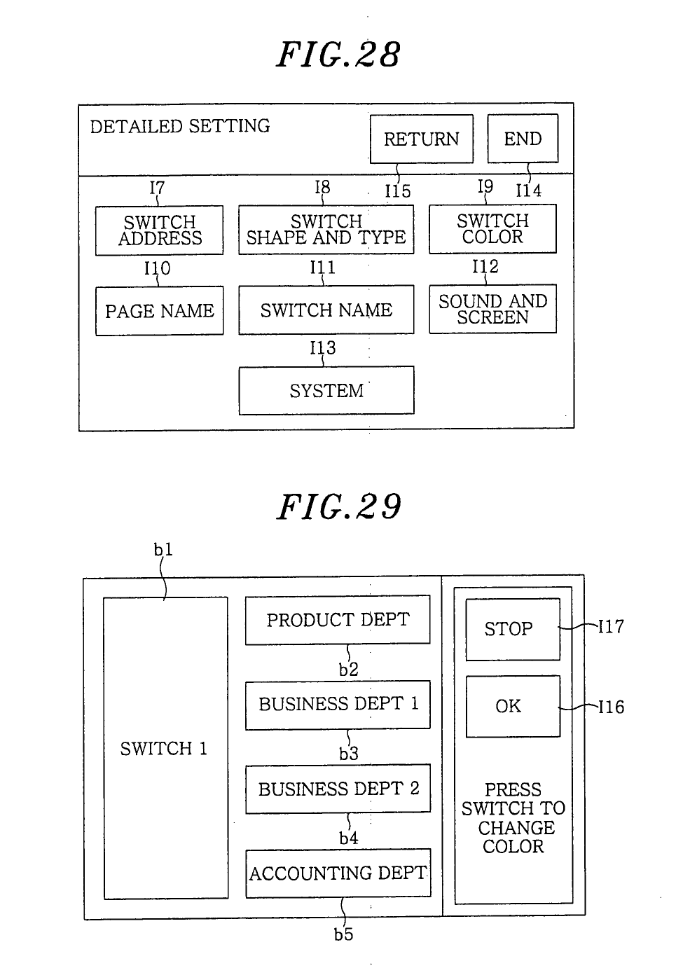

If the display color setting mode becomes available, the control unit 220 causes the communications circuit 211 to stop communications with the transmission unit 230 and allows the screen of the display panel 202 to display a display color setting page containing the operation buttons b1 through b5 as illustrated in FIG. 29. The load operation state (namely, the on-mark Mon and the off-mark Moff) is not displayed on the display color setting page. Therefore, it is impossible to perform the load control in the display color setting mode, unlike the operation mode in which the load control can be performed by operating the touch switch panel 203.

On this display color setting page, the user can touch each of the switches of the touch switch panel 203 (namely, each of the portions corresponding to the operation buttons b1 through b5) to change the display color of each of the operation buttons b1 through b5. At this time, each of the operation buttons b1 through b5 on the display color setting page is displayed in the changed color, which enables the user to confirm the changed image. The display color of each of the operation buttons b1 through b5 is selected from a plurality of predetermined colors. The display color is cyclically changed over each time of touching operation. It is preferred that the display color is selected from the clearly distinguishable colors (e.g., white, yellow and blue colors), excluding the green and red colors used in displaying the load state. The data on the display colors of the operation buttons b1 through b5 changed in the display color setting mode (hereinafter referred to as “display color data”) is stored in the temporary storage region 213b of the flash memory 213.

An icon I16 reading “OK” is displayed in the right upper portion of the display color setting page. If the icon I16 is touched, the display color data under setting operation are stored in the address memory 213a of the flash memory 213 by the control unit 220. At this moment, the display color data under setting operation are cleared from the temporary storage region 213b of the flash memory 213.

Once the task of storing the display color data in the address memory 213a comes to an end, the control unit 220 terminates the display color setting mode and causes the display panel 202 to display the setting menu page shown in FIG. 28. If an icon I17 reading “STOP” arranged at the upper side of the icon I16 is touched, the control unit 220 terminates the display color setting mode and proceeds to the setting menu page, without having to storing the display color data under setting operation in the address memory 213a. In this case, the display color data under setting operation is cleared from the temporary storage region 213b. The display color data registered in the address memory 213a prior to executing the display color setting mode is used as it stands.

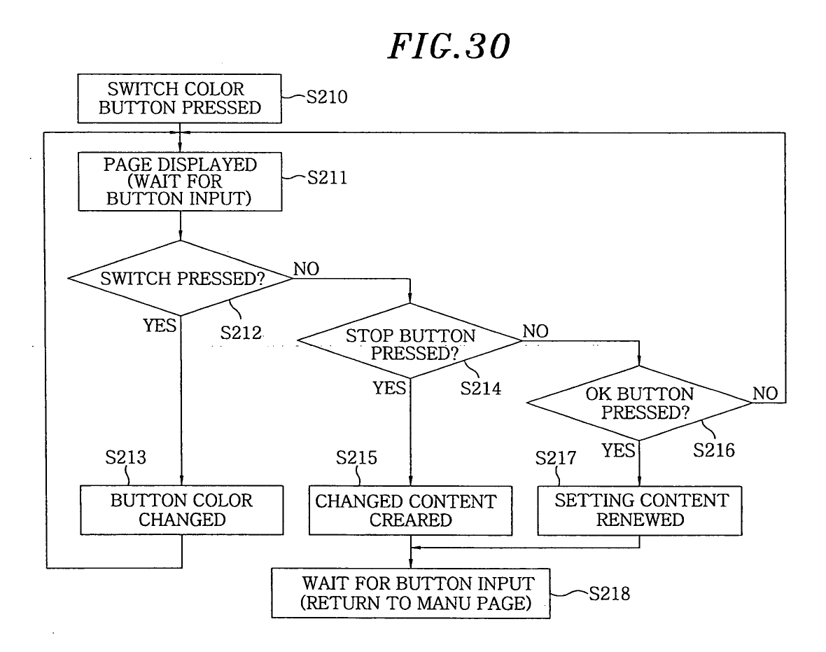

Next, the operation of the monitoring and control device 201 will be described with reference to FIG. 30, which illustrates the processing flow of the control unit 220 in the display color setting mode.

If the icon I9 reading “SWITCH COLOR” on the setting menu page is touched (step S210), the control unit 220 converts its mode to the display color setting mode and causes the display panel 202 to display the display color setting page (step S211).

If each of the switches is touched in this state (step S212), the display color of the corresponding one of the operation buttons b1 through b5 is changed every touching time (step S213). If the icon I17 reading “STOP” is touched (step S214), the changed display color data is cleared (step S215) and the screen of the display panel 202 comes back to the setting menu page (step S218). If the icon I16 reading “OK” is touched (step S216), the setting content is replaced by the changed display color data (step S217) and the screen of the display panel 202 comes back to the setting menu page (step S218).

The display colors of operation buttons b1 through b5 changed in the afore-mentioned manner are also reflected in the operation page available in the operation mode. This enables the user to easily distinguish the switches from one another, eventually providing an advantage of reducing the likelihood of occurrence of an erroneous operation. In addition, it is possible to assure enhanced operability by changing the display colors depending on the function of the switches such as the individual control and the group control.

Different setting modes other than the address-setting mode and the display color setting mode can be started from the setting menu page illustrated in FIG. 28. For example, if the icon I11 reading “SWITCH NAME” is touched, a setting mode for setting the name of each of the switches becomes available. The names of the switches set in this setting mode are displayed inside the operation buttons b1 through b5 as illustrated in FIG. 29. If the icon I12 reading “SOUND & SCREEN” is touched, there is available a setting mode for setting the output sound of the buzzer 219 or the display of the display panel 202. If the icon I13 reading “SYSTEM” is touched, there is available a setting mode for performing the basic setting of the monitoring and control device 201.

If the icon I8 reading “SWITCH SHAPE & TYPE” is touched, there is available a setting mode for changing the shape or type of the operation buttons b1 through b5. In this regard, the display color setting mode need not be an independent setting mode. Instead, the display colors of the operation buttons b1 through b5 may be set in a type-setting mode.

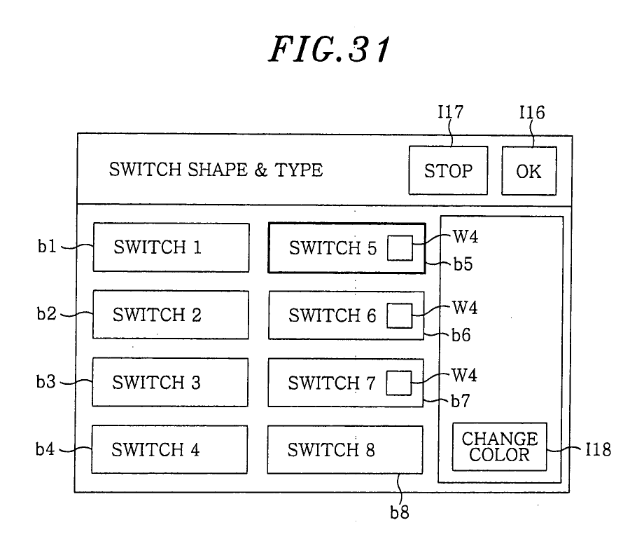

For example, a type-setting page containing the operation buttons b1 through b8 corresponding to the respective switches is displayed in the type-setting mode as illustrated in FIG. 31. In this state, the display colors of the operation buttons b1 through b8 can be changed by touching an icon I18 reading “CHANGE COLOR” arranged in the right lower portion of the screen. In the example shown in FIG. 31, the user can select one of the switches by touching each of the switches of the touch switch panel 203 (namely, each of the portions corresponding to the operation buttons b1 through b8). At this time, one of the operation buttons b1 through b8 of the switches thus selected is displayed in a highlighted state (The switch corresponding to the operation button b5 is selected in FIG. 31). In a state that one of the switches is selected, the display color of each of the operation buttons b1 through b8 corresponding to the selected switch is cyclically changed over each time the icon I18 is touched.

The display colors of the operation buttons b1 through b8 thus changed are displayed in the color confirmation windows W4 arranged inside of the operation buttons b1 through b8.

In the operation mode, it may be contemplated that the operation buttons corresponding to a multiplicity of loads are displayed by reducing the number of operation buttons displayed on one screen page of the display panel 202 and then changing over the display content. In this case, each of the screen pages of the display panel 202 can be given a page name. The page name can set by touching the icon 110 reading “PAGE NAME” arranged on the setting menu page and then starting the setting mode.

Other configurations and functions of the present embodiment remain the same as those of the sixth embodiment.

### Eighth Embodiment

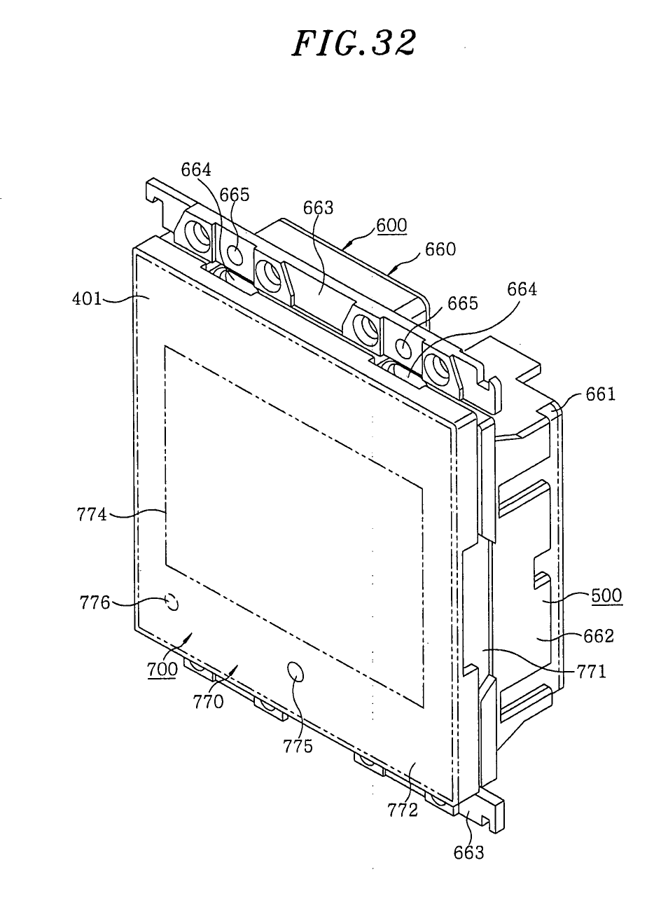

The eighth embodiment of the present invention will now be described in detail with reference to FIG. 32 through 34.

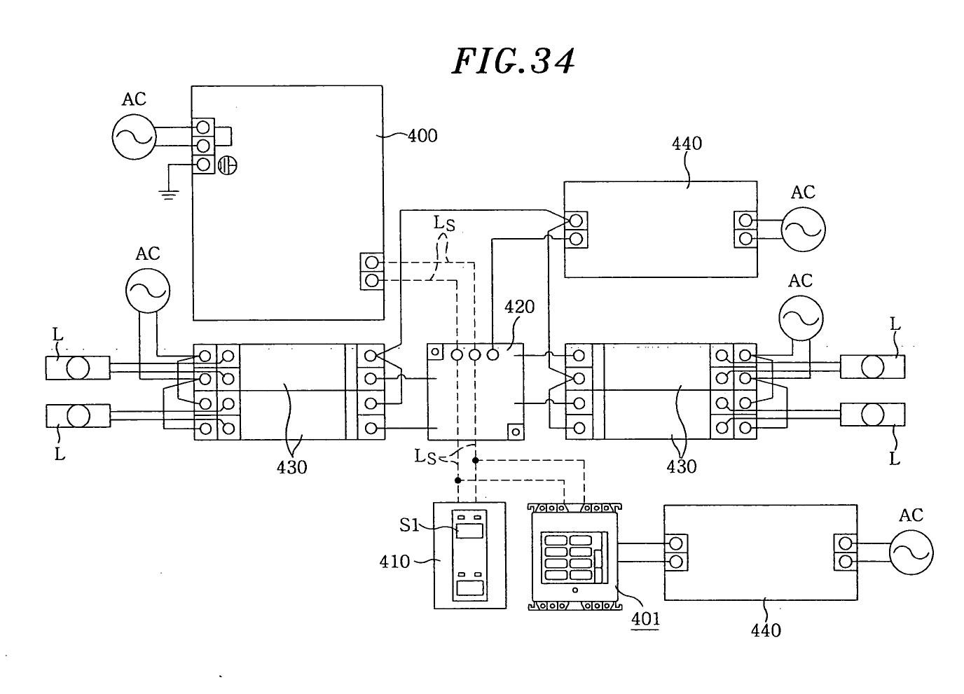

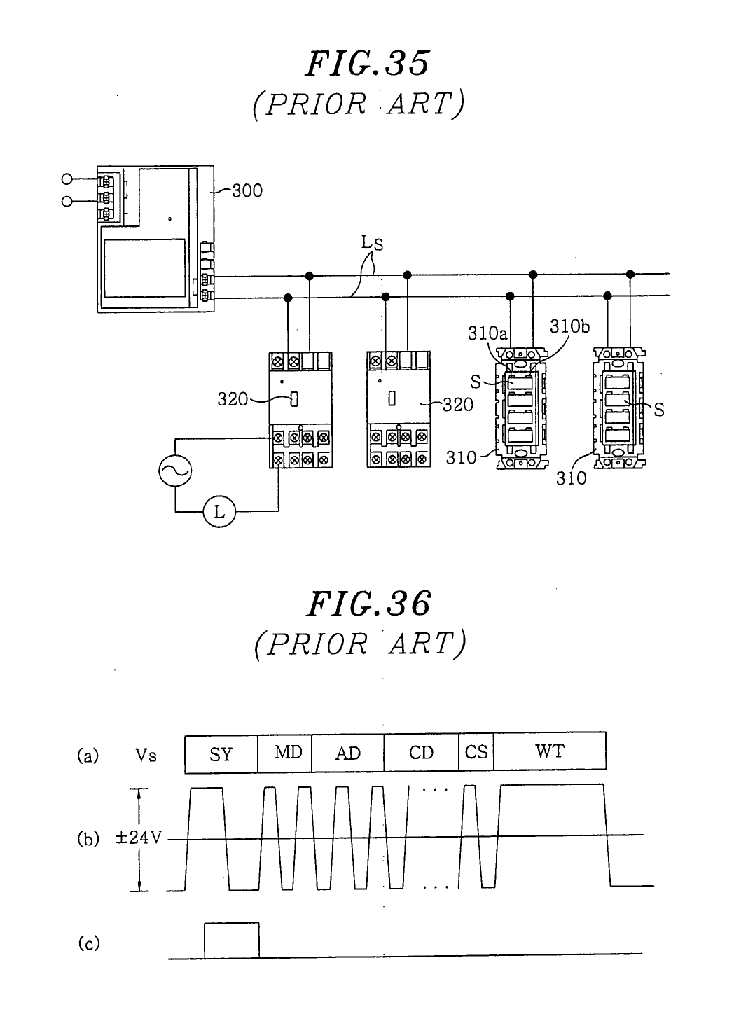

FIG. 34 is a system configuration diagram showing a remote monitoring and control system that includes the monitoring and control device 401 in accordance with the present embodiment.

In this remote monitoring and control system, it can be seen that an operation terminal 401 of the present invention, an additional operation terminal 410 (namely, a changeover operation terminal to be described later) and a control terminal 420 (a relay control terminal) are connected to a transmission control unit 400 through a two-wire type signal line Ls in a branched connection method (or in a multi-drop connection method). A control terminal 420 is designed to control a latching type remote-controlled relay 430 for permitting or interrupting the current supply from a commercial alternating current source AC to loads (e.g., illumination loads). Reference numeral 440 in FIG. 34 designates a remote-controlled transformer that derives electric power (of AC 24V) for operating the remote-controlled relay 430, the control terminal 420 and the operation terminal 401, from the commercial alternating current source AC.

Referring again to FIG. 21, the operation terminal 401 of the present embodiment includes a display panel 202, which is formed by combining a backlight with a liquid crystal display device, and an operation input reception unit formed of a transparent flat touch switch panel 203 superimposed on the screen (or the front surface) of the display panel 202. The operation terminal 401 of the present embodiment has substantially the same configurations and functions as those of the monitoring and control device 201 described in respect of the sixth embodiment (see FIG. 21). The points differing from the sixth embodiment reside in that at least the address of the operation terminal 401 is stored in the flash memory 213.

Referring to FIG. 32, the operation terminal 401 of the present embodiment includes a generally rectangular base 500 and is attached to a wall in such a fashion that the rear portion of the base 500 is embedded into the wall just like a flush-mounted wiring device. The operation terminal 401 is divided into a body unit 600 fixed to the wall so that the rear portion thereof is embedded into the wall and a panel unit 700 detachably attached to the front side of the body unit 600 so that the front portion thereof protrudes forwards from a wall surface. The operation terminal 401 includes different internal circuits divisionally provided in the body unit 600 and the panel unit 700.

In the present embodiment, a power supply circuit 210 (see FIG. 21) for supplying electric power to the internal circuits and a communications circuit 211 are provided in the body unit 600, while other circuits (including the display panel 202, the touch switch panel 203 and the main microcomputer 212) are provided in the panel unit 700.

The body unit 600 includes a body case 660 formed of a box-like main body 661 having a rectangular opening on the front surface thereof and a main cover 662 attached to the front surface of the main body 661. A circuit board (not shown) that carries different kinds of electric parts is accommodated within the body case 660. The body unit 600 is provided on its rear surface with a power supply terminal portion T1 (see FIG. 21) connected to the remote-controlled transformer 440 through a power supply line and a signal terminal portion T2 (see FIG. 21) connected to the signal line Ls.

The panel unit 700 includes a panel case 770 formed of a box-like thin panel body 771 having a rectangular opening on the front surface thereof and a panel cover 772 attached to the front surface of the panel body 771. A circuit board (not shown) carrying different kinds of electric parts such as the main microcomputer 212 and the like is accommodated within the panel case 770. In the panel unit 700, a rectangular display window 774 is formed in a portion of the front wall of the panel case 770. The display panel 202 and the touch switch panel 203 are arranged within the display window 774. Below the display window 774 and at the transverse midpoint in the front wall of the panel case 770, there is provided an operation portion 775 for operating a mechanical switch (not shown). At the left side of the operation portion 775, there is provided an LED window 776 through which to pass the light irradiated from an LED 277 (see FIG. 21). The LED 277 is normally turned on if the panel unit 700 is supplied with electric power. The LED 277 serves to notify the user of the position of the operation terminal 401 when an indoor space is dark.

The operation terminal 401 of the present embodiment is attached to the wall using a wall-mounted embedment box (not shown) for a flush-mounted wiring device. This is to reduce the protrusion amount of the base 500 from the wall surface, to give a sensation of unity in appearance with a flush-mounted wiring device which is in widespread use, and to reduce the cost of the members used for installation purposes.

The body unit 600 is inserted through an installation hole arranged on the wall surface and attached to the embedment box from the front side thereof. The body case 660 is shaped and sized so that the rear portion thereof can be accommodated within the embodiment box. In the present embodiment, the body case 660 of the body unit 600 is formed in a size corresponding to the size of the embedment box which can accommodate two installation frames (not shown) for single-row joint use. The term “installation frame for single-row joint use” used herein refers to an installation frame (for joint-use wiring devices) standardized by JIS (Japanese Industrial Standards). If two installation frames for single-row joint use are arranged side by side in a transverse direction, it is referred to as “dual-row joint use”. The body unit 206 of the present embodiment has such a size that it can be installed in the embedment box for dual-row joint use.

More specifically, the body case 660 includes a pair of attachment members 663 integrally formed on the vertical opposite ends thereof to extend away from each other. The attachment members 663 are provided in such a fashion as to protrude upwards and downwards from the front end portion of the body case 660 and to extend along the transverse full length of the body case 660. Just like the installation frame used in fixing a flush-mounted wiring device to the embedment box, each of the attachment members 663 has a plurality of (two, in the present embodiment) box attachment holes 664 through which installation screws are inserted. In the areas of the attachment members 663 above and below the box attachment holes 664, there are formed plate-fixing holes 665 for screw-fixing a decoration plate (not shown) attached to the front end portion of the base 500 so as to cover the attachment members 663.

In the meantime, the conventional operation terminals of the configuration in which the operation input of a switch is received by push button switches. Therefore, the number of switches installed in a single operation terminal is four at most. With the operation terminal 401 of the present embodiment, the touch switch panel 203 for reception of the operation input forms a touch panel display in cooperation with the display panel 202. This makes it possible for the operation terminal 401 to have five or more switches through the combination of figures or letters displayed on the display panel 202 and the touch switch panel 203.

However, it would be necessary to employ a display panel of large size in order for a single screen page to simultaneously display a multiplicity of switches corresponding to all loads to be controlled. This may result in an increase in the price and size of the operation terminal. In view of this, the screen size of the display panel 202 is reduced by simultaneously displaying a relatively small number of switches on one screen page and changing over a plurality of screen pages (hereinafter referred to as “pages”) on which different switches are displayed.

Next, description will be made on the major configuration of the present embodiment. In the operation terminal 401 of the present embodiment, the main microcomputer 212 as a control unit is selectively changed over between a permission state in which the operation input received by the touch switch panel 203 as an operation input reception unit is validated and an inhibition state in which the operation input is nullified. When in the permission state, the main microcomputer 212 performs generation of a monitoring data according to the operation input and transmission of a transmission signal containing the monitoring data. When in the inhibition state, the main microcomputer 212 is inhibited from generating the monitoring data according to the operation input. As will be set forth later, the main microcomputer 212 may be designed to nullify only the operation input corresponding to one or more switches pre-selected from a plurality of switches.

Pre-stored in the flash memory 213 as a storage unit is a specific changeover address (to be mentioned later) mated with a switch (or a changeover switch) S1 of the additional operation terminal (or the changeover operation terminal) 410. The main microcomputer 212 is changed over between the permission state and the inhibition state depending on the control data sent from the transmission control unit 400 in response to the operation of the changeover switch S1 of the changeover operation terminal 410.

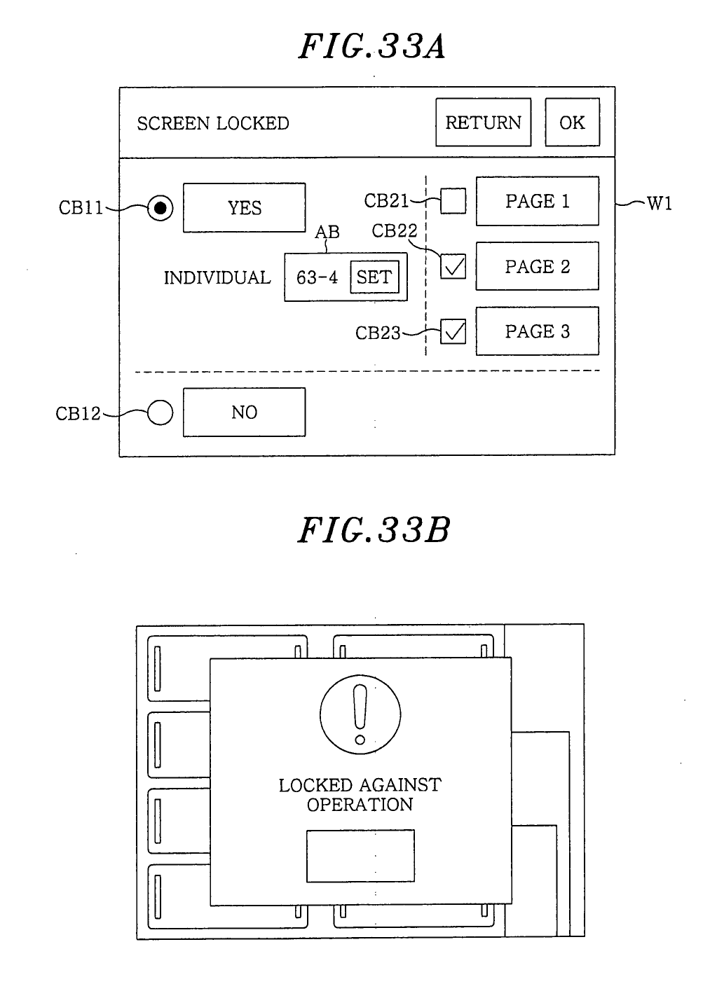

FIG. 33A illustrates a setting page W1 displayed on the display panel 202 when setting the permission state and the inhibition state in the main microcomputer 212 of the operation terminal 401. The setting page W1 can be used in selecting execution and non-execution of the changeover of the permission state and the inhibition state, selecting the switches (or the pages) to be changed over, and receiving the operation input for setting the changeover address.

In the illustrated example, the execution of the changeover of the permission state and the inhibition state is selected by checking a checkbox CB11. “PAGE 2” and “PAGE 3” are selected as changeover subjects from three pages, namely “PAGE 1”, “PAGE 2” and “PAGE 3” by checking checkboxes CB22 and CB23. An address reading “63-4” is displayed in an address display box AB. In this regard, the conventional operation terminal includes four circuits of switches at most and the conventional control terminal is capable of controlling four circuits of loads at most. The operation terminal and the control terminal are allocated two-bit load numbers for recognition of the switches and the loads. In the conventional remote monitoring and control system, the addresses of the operation terminal and the control terminal are called “channels”. The channels and the load numbers are collectively called “addresses”. Individual addresses are allocated to the switches and the loads. In the example illustrated in FIG. 33A, an address reading “63-4”, which signifies channel 63 and load number 4, is selected as the changeover address.

If the operation button (or the switch) reading “OK” displayed in the right upper portion of the setting page W1 in FIG. 33A is touched and if the operation input of the switch is received in the touch switch panel 203, the main microcomputer 212 causes the flash memory 213 to store the content selected on the setting page W1, namely the execution of the changeover of the permission state and the inhibition state for “PAGE 2” and “PAGE 4” and the address reading “63-4” as the changeover address.

The same address “63-4” as the changeover address is also allocated to the changeover switch S1 of the changeover operation terminal 410. The setting content is also registered in the transmission control unit 400. The method of allocating an address to the changeover switch S1 of the changeover operation terminal 410 and registering the address setting content in the transmission control unit 400 is well-known in the conventional remote monitoring and control system and, therefore, will be omitted from further description.

Accordingly, if the operation terminal 401 of the present embodiment is arranged in a place accessible by an unspecified number of persons and if there is a need to prevent an unspecified number of persons from inadvertently operating the switches displayed on the page 2 or the page 3, the main microcomputer 212 of the operation terminal 401 may be changed over from the permission state to the inhibition state by touching the switch S1 of the changeover operation terminal 410. Upon touching the switch S1 of the changeover operation terminal 410, a control data is transmitted from the transmission control unit 400 to the operation terminal 401. Responsive to the control data, the main microcomputer 212 of the operation terminal 401 is changed over from the permission state to the inhibition state. If the control data is received while the main microcomputer 212 remains in the inhibition state, the main microcomputer 212 may well be changed over from the inhibition state to the permission state.

In case where one of the switches reading “PAGE 2” and “PAGE 3” is operated while the main microcomputer 212 remains in the inhibition state, the main microcomputer 212 causes the display panel 202 to display a message for notifying the user of the nullified switch operation, e.g., a message reading “LOCKED AGAINST OPERATION” illustrated in FIG. 33B, for a specified time (e.g., for several seconds) and then display the original page (namely, the page 2 or the page 3).

With the operation terminal 401 of the present embodiment described above, the control unit (namely, the main microcomputer 212) can be changed over from the permission state to the inhibition state and vice versa by operating the switch S1 of the additional operation terminal (or the changeover operation terminal 410). The operation input received by the operation input reception unit (or the touch switch panel 203) is nullified in the inhibition state. Therefore, there is no need to install a relay device between the touch switch panel 203 and the transmission control unit 400, which needs to be installed in the prior art example. This provides an advantage in that it becomes possible to make the system configuration simpler than the prior art example while permitting the changeover of validation and nullification of the operation. In addition, only a limited number of switches are used as the switches for changing over the validation and nullification of the operation. This enhances the ease of use of the operation terminal 401.

In the present embodiment, the validation and nullification of the operation in the operation terminal 401 is changed over by manually operating the switch S1 of the changeover operation terminal 410. Alternatively, it may be possible to use a changeover operation terminal having a timer function by which a monitoring data is automatically transmitted at a predetermined time. This makes it possible to automatically change over the validation and nullification of the switch operation of the operation terminal 401 on a time zone basis. The operation terminal having a timer function is well-known in the art and, therefore, will be omitted from further description.

While the invention has been shown and described with respect to the embodiments, it will be understood by those skilled in the art that various changes and modification may be made without departing from the scope of the invention as defined in the following claims.

What is claimed is:

1. A monitoring and control device for use in a remote monitoring and control system to monitor and control loads by communications, comprising:
a display unit provided with a screen for displaying a plurality of operation buttons mated with the loads;
an operation input unit operable by a user, the operation input unit including a touch switch panel superimposed on the screen of the display unit; and
a control unit for performing display control of the display unit and load control in response to the operation of the operation input unit so that, if a user touches one of the operation buttons displayed on the display unit, the load corresponding to the touched operation button is controlled,
wherein the control unit includes a display control unit for causing the display unit to display one operation page selected from a plurality of operation pages containing different combinations of operation buttons and a page changeover unit for changing over the operation page displayed on the display unit in response to a user's operation.

2. The monitoring and control device of claim 1, wherein the control unit includes a display interruption unit for turning off screen display of the display unit if the operation input unit is not operated for a predetermined time, a display resumption unit for resuming the screen display of the display unit if the operation input unit is re-operated while the screen display is turned off by the display interruption unit, and a page determination unit for determining one of the operation pages to be first displayed on the display unit when the screen display is resumed by the display resumption unit.

3. The monitoring and control device of claim 2, further including a storage unit and wherein the page determination unit causes the storage unit to store, as a latest display page, the operation page displayed on the display unit immediately before the screen display is turned off by the display interruption unit, the latest display page being used as the operation page to be first displayed on the display unit when the screen display is resumed by the display resumption unit.

4. The monitoring and control device of claim 2, further including a storage unit and wherein the page determination unit causes the storage unit to store, as a registered page, one of the operation pages pre-selected by the user's operation, the registered page being used as the operation page to be first displayed on the display unit when the screen display is resumed by the display resumption unit.

5. A monitoring and control device for use in a remote monitoring and control system to monitor and control loads by communications, comprising:
a display unit provided with a screen for displaying a plurality of operation buttons mated with the loads;
an operation input unit operable by a user, the operation input unit including a touch switch panel superimposed on the screen of the display unit; and
a control unit for performing display control of the display unit and load control in response to the operation of the operation input unit so that, if a user touches one of the operation buttons displayed on the display unit, the load corresponding to the touched operation button is controlled;
a clock unit for keeping apprised of a current clock time; and
a storage unit that stores different data,
wherein the control unit includes a display control unit for causing the display unit to display one operation page selected from a plurality of operation pages containing different combinations of operation buttons, a page changeover unit for changing over the operation page displayed on the display unit in response to a user's operation, a display interruption unit for turning off screen display of the display unit if the operation of the operation input unit is not detected for a predetermined time, a display resumption unit for resuming the screen display of the display unit if the operation input unit is re-operated while the screen display is turned off by the display interruption unit, and a page determination unit for determining one of the operation pages to be first displayed on the display unit when the screen display is resumed by the display resumption unit,
wherein the storage unit stores the operation pages in a mating relationship with different time zones and the page determination unit causes the display unit to initially display, at the time of resuming the screen display, one of the operation pages corresponding to one of the time zones to which the current clock time indicated by the clock unit belongs.

6. The monitoring and control device of claim 5, wherein the time zones are defined within a day.

7. The monitoring and control device of claim 5, wherein the time zones are defined day-by-day in a one-week cycle.

8. A monitoring and control device for use in a remote monitoring and control system that includes an operation terminal provided with one or more switches each having a specific address and designed to deliver a transmission signal containing the address to a signal line in response to the operation of the switches, and a control terminal responsive to the transmission signal for controlling a load corresponding to the operated switch, the monitoring and control device comprising:
an operation input unit provided with one or more switches;
an address memory that stores the address of each of the switches; and
a control unit operable in two active modes including an operation mode in which a transmission signal containing the address is delivered to the signal line in response to at least the operation of the switches and an address-setting mode in which the address to be stored in the address memory is set,
wherein the control unit includes an operation checkup unit for starting an operation checkup mode in which the address-setting mode is stopped as a specified operation is made by the operation input unit during the address-setting mode and in which a transmission signal containing a provisional address composed of the address under setting operation is delivered to the signal line, the control unit being designed to resume the address-setting mode if the operation checkup mode comes to an end.

9. The monitoring and control device of claim 8, further including a state display unit for displaying an operation state of the load mated with each of the switches, while the control unit is in one of the operation mode and the operation checkup mode.

10. The monitoring and control device of claim 8, wherein the operation input unit includes a touch panel display including a display unit for displaying letters and figures in color and a touch switch panel superimposed on a screen of the display unit and touch-operated by a user, the areas of the touch switch panel defined by operation buttons displayed on the screen of the display unit being used as the switches, the control unit being operable in a display color setting mode in which the display colors of the operation buttons displayed on the display unit are set on a switch-by-switch basis.

11. An operation terminal for use in a remote monitoring and control system that includes an operation terminal provided with a plurality of switches each having a specific address, a control terminal connected to a plurality of loads each having a specific address, and a transmission control device connected to a signal line to which the operation terminal and the control terminal are connected in a branched manner, the transmission control device being designed to generate a control data for controlling one of the loads, in response to a monitoring data sent from the operation terminal when one of the switches is operated, and to transmit the control data to the control terminal connected the load having a mating relationship with the operated switch, the transmission control device being designed to, upon receiving an interrupt signal from the operation terminal through the signal line, search for the address of the operation terminal as a source of the interrupt signal, the operation terminal being designed to return a transmission signal containing the address thereof to the transmission control device in response to the address-searching operation of the transmission control device, the operation terminal comprising:
a transmission unit for transmitting the transmission signal and the interrupt signal through the signal line;
an operation input reception unit provided with a plurality of switches and designed to receive an operation input of each of the switches;
a storage unit that stores the address; and
a control unit for generating a monitoring data in response to the operation input received by the operation input reception unit and for causing the transmission unit to transmit a transmission signal containing the monitoring data,
wherein the storage unit is designed to store a specific changeover address having a mating relationship with a switch of an additional operation terminal,
wherein the control unit is designed to selectively change over a permission state in which the operation input received by the operation input reception unit is validated and an inhibition state in which the operation input is nullified, to perform generation of the monitoring data in response to the operation input and transmission of the transmission signal containing the monitoring data when in the permission state, to generate no monitoring data in response to the operation input when in the inhibition state, and to change over the permission state and the inhibition state in response to a control data sent from the transmission control device when the switch of the additional operation terminal having the changeover address is operated.

12. The operation terminal of claim 11, wherein the control unit is designed to nullify only the operation input corresponding to one or more switches pre-selected from a plurality of switches.
